(19) United States
(12) Patent Application Publication
(10) Pub. No.: US 2022/0277571 A1
(43) Pub. Date: Sep. 1, 2022

(54) SYSTEM, METHOD AND COMPUTER-READABLE MEDIUM FOR SUPPORTING ANNOTATION

(71) Applicant: OLYMPUS CORPORATION, Tokyo (JP)

(72) Inventors: Takayuki NAKATOMI, Tokyo (JP); Satoshi ISHII, Tokyo (JP); Shintaro TAKAHASHI, Tokyo (JP); Masakazu FUJII, Tokyo (JP)

(73) Assignee: OLYMPUS CORPORATION, Tokyo (JP)

(21) Appl. No.: 17/668,536

(22) Filed: Feb. 10, 2022

(30) Foreign Application Priority Data
Feb. 26, 2021 (JP) 2021-031192

(51) Int. Cl. G06V 20/69; G06V 10/764; G06V 10/22; G06V 10/75; G06V 20/70

(52) U.S. Cl. CPC G06V 20/698; G06V 10/764; G06V 10/225; G06V 10/75; G06V 20/70; G06V 2201/07

(57) ABSTRACT

An image annotation support system generates classification information that classifies a plurality of target regions constituting a target image, based on a feature represented in the target image, the target image being an image serving as a candidate to be annotated, and arranges, on a screen of a display device, a classified image that visualizes the classification information, in a manner capable of being compared with the target image.

### CROSS REFERENCE TO RELATED APPLICATIONS

This application is based upon and claims the benefit of priority of the prior Japanese Patent Application No. 2021-031192, filed Feb. 26, 2021, the entire contents of which are incorporated herein by reference.

### BACKGROUND OF THE INVENTION

### Field of the Invention

The disclosure of this specification relates to a system, a method and a computer-readable medium for supporting annotation for an image.

### Description of the Related Art

Currently, in the field of cell culture, culture states are grasped non-invasively from images using trained models constructed through execution of supervised learning. Incidentally, construction of a trained model used for image processing requires a large amount of training data including tagged images (with correct labels). An operation of creating such training data is called annotation.

In annotation, each of a large amount of images are manually tagged by people. The amount of operation is enormous. A technology of reducing the operation load for annotation is required. A technique related to such a problem is described in Japanese Patent Laid-Open No. 2017-009314, for example. Japanese Patent Laid-Open No. 2017-009314 discloses user interfaces suitable for annotation.

### SUMMARY OF THE INVENTION

An image annotation support system according to an aspect of the present invention includes: a processor and a memory, the processor being configured to perform the following steps: generating classification information that classifies a plurality of target regions constituting a target image, based on a feature represented in the target image, the target image being an image serving as a candidate to be annotated; and arranging, on a screen of a display device, a classified image that visualizes the classification information, in a manner capable of being compared with the target image. An image annotation support system according to another aspect of the present invention includes: a processor and a memory, the processor being configured to perform the following steps: generating classification information that classifies a plurality of target regions constituting a target image, based on a feature represented in the target image, the target image being an image serving as a candidate to be annotated; and arranging, on the screen of a display device, a plurality of the classified images in which a plurality of pieces of generated classification information are visualized and which correspond to a plurality of the target images respectively taken at times different from each other, based on the times of the plurality of target images being taken.

An image annotation support method according to an aspect of the present invention includes: generating classification information that classifies a plurality of target regions constituting a target image, based on a feature represented in the target image, the target image being an image serving as a candidate to be annotated; and arranging, on a screen of a display device, a classified image that visualizes the classification information, in a manner capable of being compared with the target image.

An image annotation support method according to another aspect of the present invention includes: generating classification information that classifies a plurality of target regions constituting a target image, based on a feature represented in the target image, the target image being an image serving as a candidate to be annotated; and arranging, on the screen of a display device, a plurality of the classified images in which a plurality of pieces of generated classification information are visualized and which correspond to a plurality of the target images respectively taken at times different from each other, based on the times of the plurality of target images being taken.

A non-transitory computer-readable medium storing an image annotation support program according to an aspect of the present invention, the program causing a computer to execute processes of: generating classification information that classifies a plurality of target regions constituting a target image, based on a feature represented in the target image, the target image being an image serving as a candidate to be annotated; and arranging, on a screen of a display device, a classified image that visualizes the classification information, in a manner capable of being compared with the target image.

A non-transitory computer-readable medium storing an image annotation support program according to another aspect of the present invention, the program causing a computer to execute processes of: generating classification information that classifies a plurality of target regions constituting a target image, based on a feature represented in the target image, the target image being an image serving as a candidate to be annotated; and arranging, on the screen of a display device, a plurality of the classified images in which a plurality of pieces of generated classification information are visualized and which correspond to a plurality of the target images respectively taken at times different from each other, based on the times of the plurality of target images being taken.

### BRIEF DESCRIPTION OF THE DRAWINGS

The present invention will be more apparent from the following detailed description when the accompanying drawings are referenced.

FIG. 1 exemplifies a configuration of a system 200 according to a first embodiment.

FIG. 2 exemplifies the configuration of an imaging device 100.

FIG. 3 exemplifies configurations of light source units 104 and an imaging unit 105.

FIG. 4 exemplifies the configuration of a control apparatus 130.

FIG. 5 is a flowchart showing an example of processes executed by the system 200 according to the first embodiment.

FIG. 6 shows an example of an annotation screen.

FIG. 7 shows another example of an annotation screen.

FIG. 8 shows still another example of an annotation screen.

FIG. 9 shows yet another example of an annotation screen.

FIG. 10 is a flowchart showing an example of processes executed in a learning stage by the system 200.

FIG. 11 is a flowchart showing an example of a learning process in a feature extraction method.

FIG. 12 shows an example of a feature extraction model M1.

FIG. 13 is a flowchart showing an example of a learning process in a normalization method.

FIG. 14 is a flowchart showing an example of a learning process in an information amount reduction method.

FIG. 15 is a flowchart showing an example of a learning process in a classification method.

FIG. 16 is a flowchart showing an example of a classification process by the system 200.

FIG. 17 exemplifies a former half of input and output in the classification process.

FIG. 18 exemplifies a latter half of the input and output in the classification process.

FIG. 19 is a diagram for illustrating a classified image generation method.

FIG. 20 shows still another example of an annotation screen.

FIG. 21 is a diagram showing situations of changing colors to be assigned to a class.

FIG. 22 exemplifies classified images before and after changing of color assignment shown in FIG. 21.

FIG. 23 is another diagram showing situations of changing colors to be assigned to a class.

FIG. 24 exemplifies classified images before and after changing of color assignment shown in FIG. 23.

FIG. 25 shows still another example of an annotation screen.

FIG. 26 is a diagram for illustrating a method of determining the transmissivity of the classified images.

FIG. 27 shows another example of the classified image.

FIG. 28 shows still another example of the classified image.

FIG. 29 is a flowchart showing an example of processes executed by the system according to a second embodiment.

FIG. 30 is a flowchart showing an example of a time lapse imaging process.

FIG. 31 shows an example of classified images arranged in a time-series order.

FIG. 32 shows situations where a selection operation is applied to the classified images arranged in a time-series order.

FIG. 33 shows an example of culture data list screen.

FIG. 34 shows an example of a culture data top screen.

FIG. 35 shows an example of time-series display screen.

FIG. 36 shows an example of a pasted image display screen.

FIG. 37 shows an example of a pasted element image display screen.

FIG. 38 is a flowchart showing an example of processes executed by the system according to a third embodiment.

FIG. 39 is a diagram for illustrating a method of selecting a classified image.

FIG. 40 shows another example of classified images arranged in a time-series order.

FIG. 41 is a flowchart showing an example of processes executed by the system according to a fourth embodiment.

FIG. 42 is a diagram for illustrating a method of determining the transmissivity of the classified image.

FIG. 43 is a flowchart showing an example of processes executed by the system according to a fifth embodiment.

FIG. 44 shows still another example of an annotation screen.

FIG. 45 is a diagram for illustrating an annotation adjustment method.

FIG. 46 is a diagram for illustrating the annotation adjustment method.

FIG. 47 is a diagram for illustrating the annotation adjustment method.

FIG. 48 shows an example of a graph display of classification information.

FIG. 49 exemplifies a configuration of a system 300.

### DESCRIPTION OF THE EMBODIMENTS

The technology described in Japanese Patent Laid-Open No. 2017-009314 is adopted, which allows operations of a user for annotation to be supported. As a result, the annotation efficiency can be expected to be improved. However, the technology described in Japanese Patent Laid-Open No. 2017-009314 supports the operations of the user, but does not support various types of determination required for the user for annotation. For example, determination about which region should be tagged remains to be up to the user. No technology of supporting such determination is described.

Hereinafter, embodiments of the present invention are described.

### First Embodiment

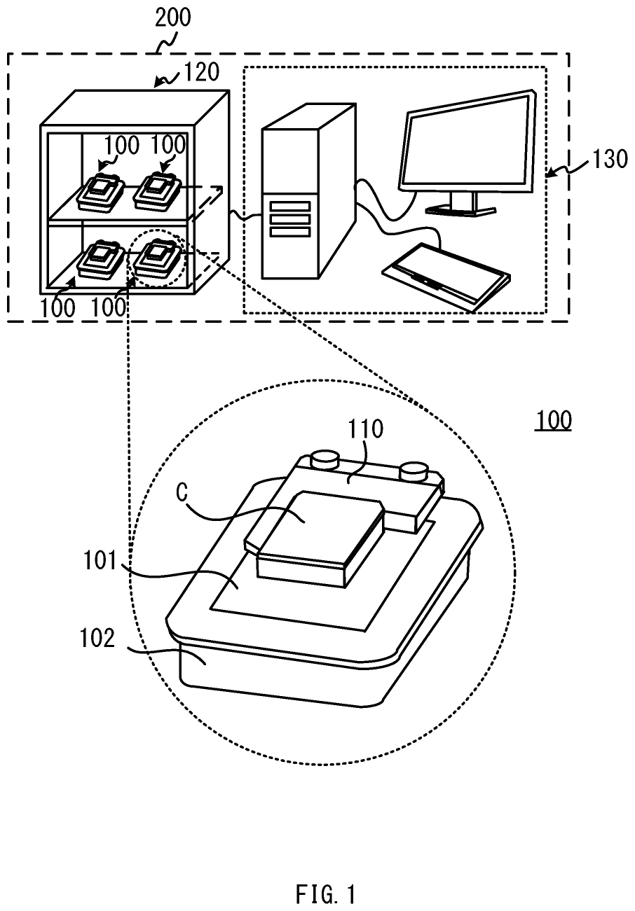

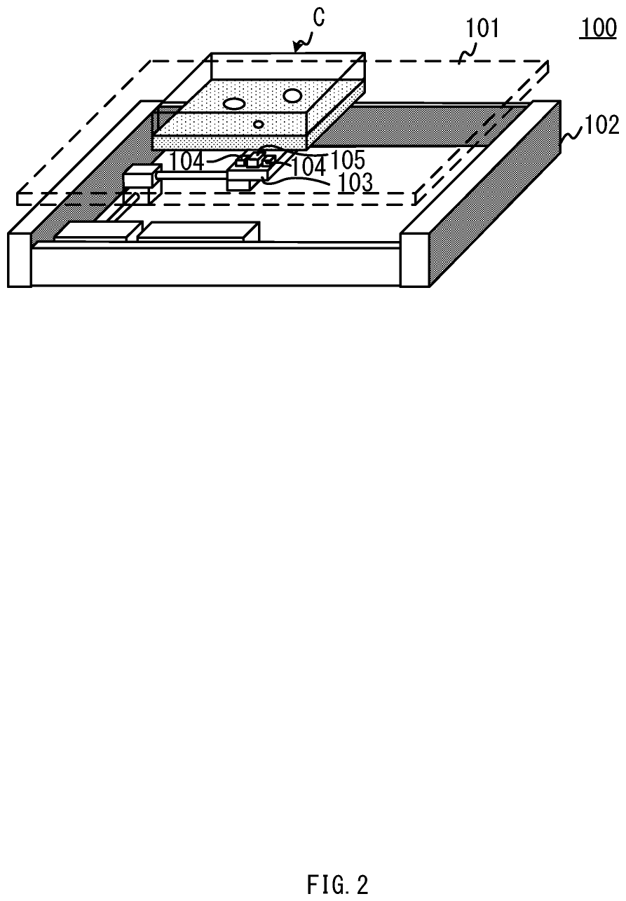

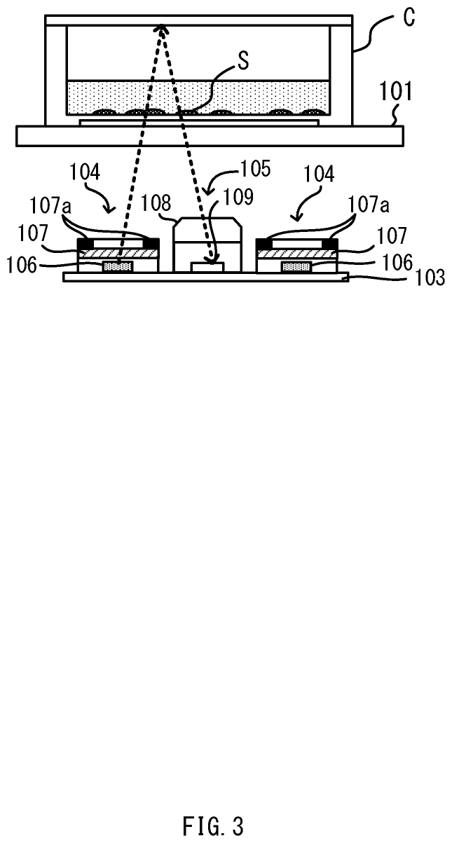

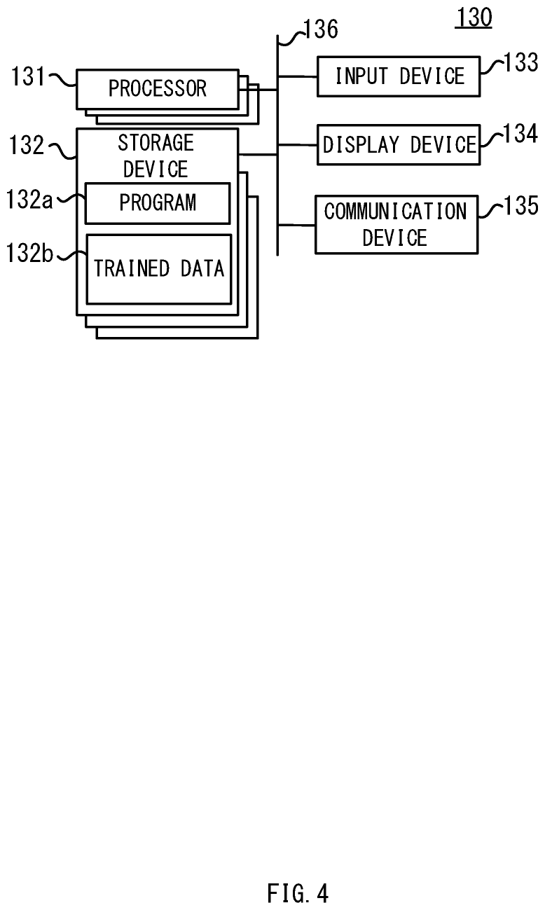

FIG. 1 exemplifies the configuration of a system 200 according to this embodiment. FIG. 2 exemplifies the configuration of an imaging device 100. FIG. 3 exemplifies configurations of light source units 104 and an imaging unit 105. FIG. 4 exemplifies the configuration of a control apparatus 130. Hereinafter, referring to FIGS. 1 to 4, the configuration of the system 200 is described.

The system 200 shown in FIG. 1 is a cell culture system that images cells contained in a vessel C while culturing the cells. Furthermore, the system 200 is a system that supports annotation to images. Here, the annotation is an operation of assigning the images information (tags) and creating training data, or is each of pieces of information (tags) assigned to the images by the annotation as the operation.

The system 200 includes: one or more imaging devices 100 that image cultured cells contained in the vessel C from below the vessel C; and a control apparatus 130 that controls the imaging devices 100. It is only required that each of the imaging devices 100 and the control apparatus 130 can mutually exchange data. Consequently, each of the imaging devices 100 and the control apparatus 130 can be wiredly, communicably connected to each other, or wirelessly, communicably connected. The vessel C that contains the cultured cells is, for example, a flask. However, the vessel C is not limited to a flask, and may be another culture vessel, such as a dish, or a well plate.

To image the cultured cells without taking out of an incubator 120, the imaging device 100 is used in a state of being arranged in the incubator 120, for example. More specifically, as shown in FIG. 1, the imaging device 100 is arranged in the incubator 120 in a state where the vessel C is mounted on a transparent window 101 of the imaging device 100, and obtains an image of a specimen (cells) in the vessel C according to an instruction from the control apparatus 130. Note that the transparent window 101 is a transparent top board constituting an upper surface of a housing 102 of the imaging device 100, and constitutes a mounting surface on which the culture vessel is mounted. The transparent window 101 is made of glass or transparent resin, for example.

As shown in FIG. 1, the imaging device 100 includes: the box-shaped housing 102 that includes the transparent window 101, as an upper surface, which is transparent and on which the vessel C is arranged; and a positioning member 110 that positions the vessel C at a predetermined position on the transparent window 101 (mounting surface). Note that the positioning member 110 is fixed to the housing 102. The positioning member 110 can be detached as required, and may be replaced with another positioning member having a different shape depending on a vessel to be used.

As shown in FIGS. 2 and 3, the imaging device 100 further includes: a stage 103 that moves in the housing 102; a pair of light source units 104 that illuminate cultured cells; and an imaging unit 105 that images the cultured cells. The stage 103, the light source unit 104, and the imaging unit 105 are internally contained in the housing 102. The light source unit 104 and the imaging unit 105 are arranged on the stage 103. The stage 103 moves in the housing 102, thereby moving the units with respect to the vessel C.

The stage 103 changes the relative position of the imaging unit 105 with respect to the vessel C. The stage 103 is movable in the X direction and the Y direction that are parallel to the transparent window 101 (mounting surface) and are orthogonal to each other. Note that the stage 103 may further move also in the Z direction (height direction) orthogonal to both the X direction and the Y direction.

Note that FIGS. 2 and 3 show the example where the light source units 104 and the imaging unit 105 are arranged on the stage 103, and resultantly move in the housing 102 in an integrated manner. The light source units 104 and the imaging unit 105 may independently move in the housing 102. FIGS. 2 and 3 show the example where the pair of light source units 104 are arranged left and right allowing the imaging unit 105 to intervene therebetween. The arrangement and the number of light source units 104 are not limited to this example. For example, three or more light source units 104 may be provided on the stage 103. Alternatively, only one unit may be provided.

As shown in FIG. 3, each light source unit 104 includes a light source 106, and a diffuser panel 107. The light source 106 may include, for example, a light emitting diode (LED). The light source 106 may include a white LED, or include multiple LEDs emitting light beams having different wavelengths, such as of R (red), G (green) and B (blue). The light emitted from the light source 106 enters the diffuser panel 107.

The diffuser panel 107 diffuses the light emitted from the light source 106. Although not specifically limited, the diffuser panel 107 is, for example, a frost-type diffuser panel on which irregularities are formed on the surface. Note that the diffuser panel 107 may be a surface-coated opal-type diffuser panel, or a diffuser panel of another type. Furthermore, masks 107a for limiting a diffusion light emission region may be formed on the diffuser panel 107. The light emitted from the diffuser panel 107 travels in various directions.

As shown in FIG. 3, the imaging unit 105 includes an optical system 108, and an image pick-up element 109. The optical system 108 condenses light having passed through the transparent window 101 and then entered the housing 102. The optical system 108, which focuses on the bottom surface of the vessel C in which cultured cells reside, condenses the light having entered the housing 102, on the image pick-up element 109, thereby forming an optical image of the cultured cells on the image pick-up element 109.

The image pick-up element 109 is an optical sensor that converts the detected light into an electric signal. Although not specifically limited, for example, a CCD (charge-coupled device) image sensor, a CMOS (complementary MOS) image sensor or the like is used as the image pick-up element 109.

The imaging device 100 configured as described above adopts oblique illumination in order to visualize a specimen S (cultured cells), which is a phase object, in the vessel C. Specifically, the light emitted by the light source 106 is diffused by the diffuser panel 107, and is emitted to the outside of the housing 102. That is, the light source units 104 emit light, which is to travel in various directions, to the outside of the housing 102 without through the optical system 108. Subsequently, a part of light emitted to the outside of the housing 102 is, for example, reflected by the upper surface of the vessel C, and is deflected above the specimen S. Part of the light deflected above the specimen S is emitted to the specimen S, and passes through the specimen S and the transparent window 101, and enters the housing 102 accordingly. Part of the light having entered the housing 102 is condensed by the optical system 108, and an image of the specimen S is formed on the image pick-up element 109. Lastly, the imaging device 100 generates an image of the specimen S (cultured cells) on the basis of an electric signal output from the image pick-up element 109, and outputs the image to the control apparatus 130.

The control apparatus 130 is an apparatus that controls the imaging device 100. The control apparatus 130 transmits an imaging instruction to the imaging device 100 arranged in the incubator 120, and receives an image taken by the imaging device 100.

The control apparatus 130 is an image processing apparatus that processes the image taken by the imaging device 100. The control apparatus 130 generates classification information that classifies a region constituting the image into some classes on the basis of the feature of the image extracted from this image.

Furthermore, the control apparatus 130 is a display control apparatus that visualizes and displays the classification information. The control apparatus 130 visualizes the classification information and arranges the information on a screen, in response to a request issued by a user. Hereinafter, the image where the classification information is visualized is described as a classified image.

Note that the control apparatus 130 may be what includes one or more processors, and one or more non-transitory computer-readable media, and is a typical computer, for example. More specifically, as shown in FIG. 4, the control apparatus 130 may include, for example, one or more processors 131, one or more storage devices 132, an input device 133, a display device 134, and a communication device 135, which may be connected to each other via a bus 136.

Each of the one or more processors 131 is, for example, hardware that includes a CPU (central processing unit), a GPU (graphics processing unit), and a DSP (digital signal processor), and executes a program 132a stored in the one or more storage devices 132, thereby performing programmed processes. The programed processes include, for example, a classification process of generating the classification information, and a display control process of arranging classified images on the screen. That is, the processor 131 is an example of a classification unit of the system 200, and is an example of a control unit of the system 200. The one or more processors 131 may include an ASIC (application specific integrated circuit), and an FPGA (field-programmable gate array).

Each of the one or more storage devices 132 includes, for example, one or more freely selected semiconductor memories, and may further include one or more other storage devices. The semiconductor memories include, for example, volatile memories such as RAMs (random access memories), and nonvolatile memories such as ROMs (read only memories), programmable ROMs and flash memories. The RAMs may include, for example, DRAMs (dynamic random access memories), and SRAMs (static random access memories). The other storage devices may include, for example, magnetic storage devices that include magnetic disks, and optical storage devices that include optical disks.

Note that the one or more storage devices 132 are non-transitory computer-readable media, and are examples of storage units of the system 200. At least one of the storage devices 132 stores trained data 132b, which is to be used for generating the classified image.

The input device 133 is a device that the user directly operates, and is, for example, a keyboard, a mouse, a touch panel, etc. The display device 134 may be, for example, a liquid crystal display, an organic EL display, a CRT (cathode ray tube) display, etc. The display may internally include a touch panel. The communication device 135 may be a wired communication module, or a wireless communication module.

Note that the configuration shown in FIG. 4 is an example of the hardware configuration of the control apparatus 130. The control apparatus 130 is not limited to this configuration. The control apparatus 130 is not limited to a general purpose apparatus, but may be a dedicated apparatus.

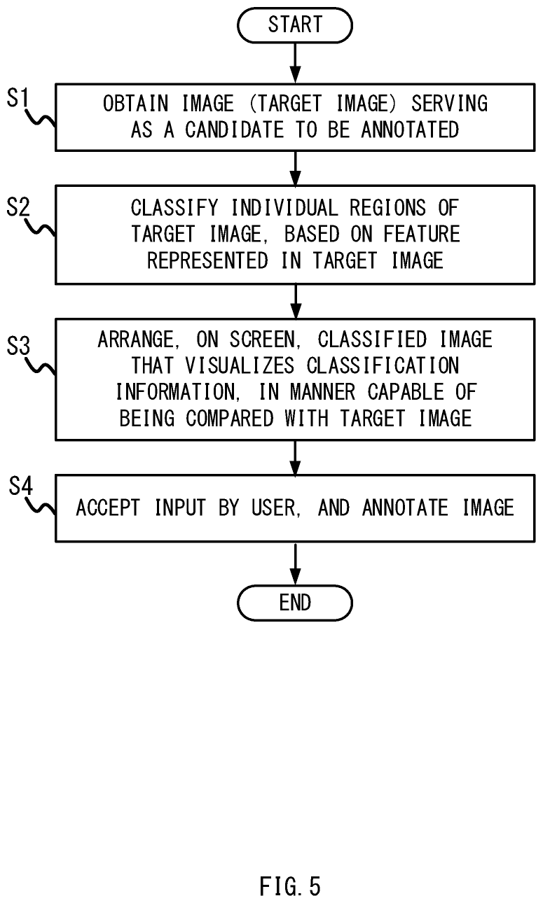

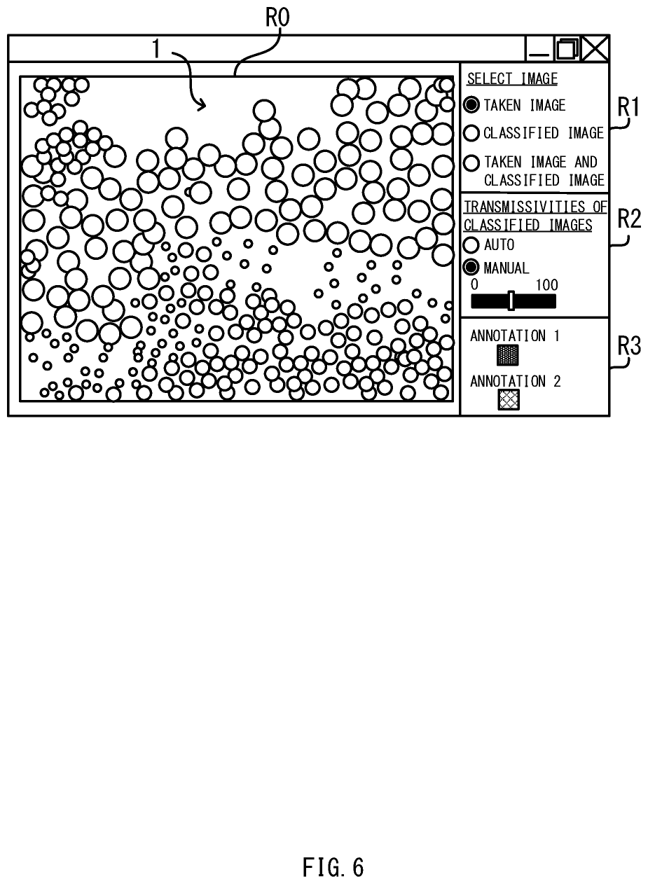

FIG. 5 is a flowchart showing an example of processes executed by the system 200 according to this embodiment. FIGS. 6 to 9 exemplify annotation screens. The annotation screen is a screen that can assign an annotation to an image on the basis of an operation by the user. By applying the process shown in FIG. 5, the system 200 provides an operation environment for assigning annotations to images, together with information supporting various types of determination that is to be made by the user during annotation. Hereinafter, referring to FIGS. 5 to 9, a specific example of the method of supporting annotation performed by the system 200 is described. The processes shown in FIG. 5 are started by the processors 131 executing the program 132a.

When the processes shown in FIG. 5 are started, first the system 200 obtains an image serving as a candidate to be annotated (step S1). Here, the imaging device 100 images the cultured cells in the vessel C, and obtains an image serving as a candidate to be annotated (hereinafter, described as a target image). Furthermore, the imaging device 100 outputs the obtained target image to the control apparatus 130.

Next, the system 200 classifies individual regions of the target image on the basis of the feature represented in the target image (step S2). Here, the control apparatus 130 obtains the target image output from the imaging device 100. Furthermore, in the control apparatus 130, the processors 131, which are an example of the classification unit, use the trained data 132b stored in the storage devices 132 to thereby generate classification information that classifies a plurality of target regions constituting the target image on the basis of the feature represented in the target image.

Note that each of the target regions is, for example, one or more pixels included in the target image. One pixel may constitute one target region. A plurality of pixels (e.g., 3×3 pixels) may constitute one target region. The number of divisions of the target regions may be freely defined by the user or the system. For example, the case where the number of pixels of 3*3 is adopted as the division unit has been exemplified. However, the vertical and lateral numbers of pixels are not necessarily the same. The classification information includes at least pieces of class information that correspond to the respective target regions. The class information is information that indicates the classes into which the corresponding target regions are classified.

When the classification information is generated, the system 200 arranges classified image that visualizes the classification information on a screen of the display device 134 in a manner capable of being compared with the target image (step S3). Here, in the control apparatus 130, the processors 131, which are an example of a control unit, assign each region a color or a pattern associated with the class into which the corresponding region is classified, thereby generating the classified image that visualizes the classification information. Furthermore, the processors 131 arrange the classified image on the annotation screen in a manner capable of being compared with the target image.

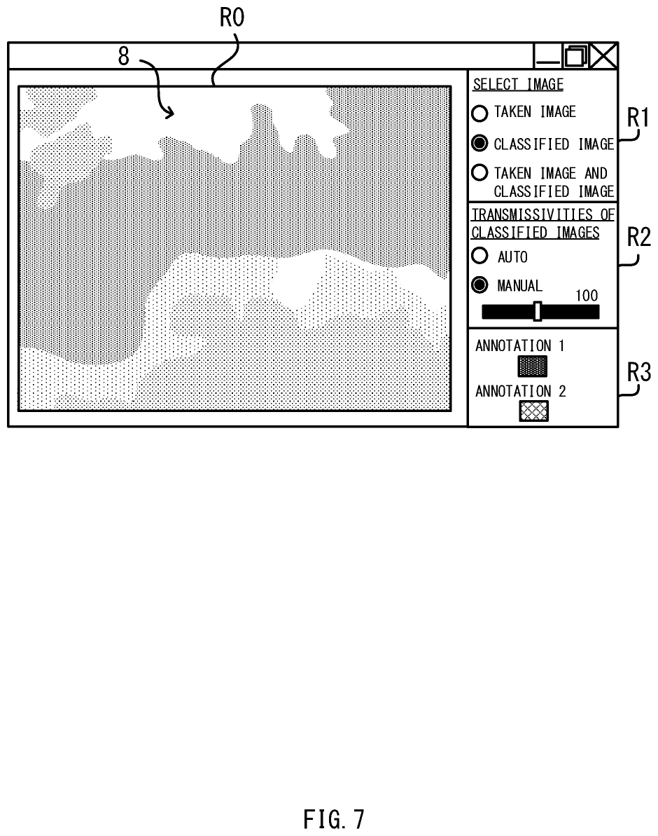

FIG. 6 shows situations where “TAKEN IMAGE” is selected in a region R1, and resultantly, a target image (image 1) taken by the imaging device 100 is arranged in a region R0. FIG. 7 shows situations here “CLASSIFIED IMAGE” is selected in the region R1, and resultantly a classified image (image 8) is arranged in the region R0. In step S3, the processors 131 may arrange, on the screen, the image 1 that is the target image and the image 8 that is the classified image in a switchable manner as shown in FIGS. 6 and 7, thereby allowing the classified image to be compared with the target image. Note that switching between the image 1 and the image 8 may be performed by an operation of the user (e.g., selection of a radio button in the region R1), or may be performed automatically without any operation of the user. For example, the image 1 and the image 8 may be switched every certain time periods.

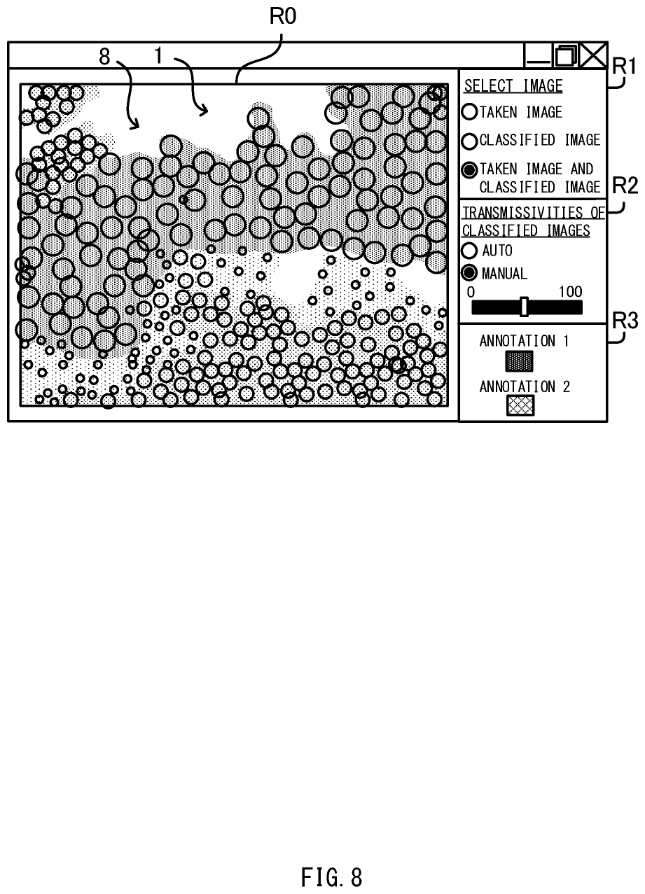

FIG. 8 shows situations where “TAKEN IMAGE AND CLASSIFIED IMAGE” are selected in the region R1, and resultantly, the target image (image 1) and the classified image (image 8) are arranged in the region R0 in a superimposed manner. That is, the control apparatus 130 superimposes the classified image on the target image. Furthermore, the control apparatus 130 can change the transmissivity of the classified image to be superimposed on the target image, according to a predetermined instruction (e.g., an operation for the region R2). Accordingly, the user can confirm both the images at the same time. In step S3, the processors 131 may arrange, on the screen, the image 1 that is the target image and the image 8 that is the classified image in a superimposed manner as shown in FIG. 8, thereby allowing the classified image to be compared with the target image.

Note that FIG. 8 shows the example allowing the transmissivity of the classified image to be adjusted in the region R2. However, it is only required that the transmissivity of at least one of the target image and the classified image is adjustable. The transmissivity may be automatically adjusted. For example, the transmissivity may be adjusted according to an operation of requesting a display of an enlarged image.

After the classified image is arranged on the screen, the system 200 accepts an input by the user, and annotates the image (step S4). First, the user herein determines the target image displayed on the screen as an image to be annotated. Input for annotating the target image is performed. In response to this, the processors 131 annotate the target image according to the input by the user, and generates training data.

By the system 200 performing the processes shown in FIG. 5, the system 200 can support annotation by the user. Hereinafter, this point is specifically described.

First, the classified image is displayed, which allows the user to roughly determine a portion to be annotated. As described above, this is because the image visualizes classification information (including the class information) where the classified image is classified based on the feature of the target image.

More specifically, the classification information can be assumed to be generated by the classification unit grasping, as a pattern, cells taken in the target image and classifying the difference in texture in the target image caused by the difference in the size of cells and contrast. Accordingly, it can be regarded that cells and the like having forms similar in appearance are taken in regions classified into the same class among the regions of the target image. Conversely, it can be regarded that cells and the like having forms different in appearance are taken in regions classified into different classes among the regions of the target image. For example, it is assumed that for an image of iPS cells in culture, undifferentiated regions and differentiated regions are annotated. The undifferentiated regions and the differentiated regions have different forms, and are classified into different classes accordingly. Meanwhile, the undifferentiated regions (or differentiated regions) have similar forms, and are classified into the same class accordingly. Consequently, when a target image where undifferentiated regions and differentiated regions are mixed is taken, the user can expect that a region associated with any class in a classified image generated from the target image is an undifferentiated region, and they can roughly discriminate the undifferentiated region from the classified image on the basis of the assumption. Likewise, also for the differentiated region, the differentiated region can be roughly determined from the classified image.

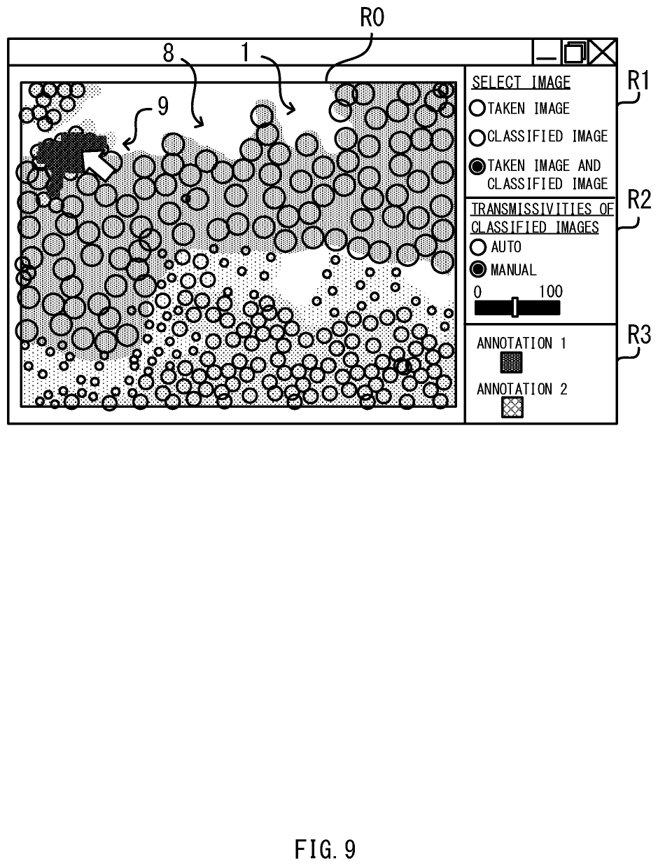

Furthermore, the classified image is arranged in a manner capable of comparison with the target image, which allows the user to verify the target image with respect to the portion roughly determined using the classified image, and determine whether the portion is a portion to be annotated or not. Note that FIG. 9 shows situations where with reference to the classified image (image 8), the target image (image 1) viewable through the classified image is assigned an annotation 9. The type of the annotation to be assigned can be selected in the region R3, for example. As described above, the user is allowed to verify in detail the target image with respect to a range narrowed down to a certain extent using the classified image. Accordingly, the annotation can be correctly and efficiently assigned.

As described above, the system 200 can display the classified image, which can provide an operator performing annotation with information for supporting various types of determination. Accordingly, the efficiency and reliability of annotation can be expected to be improved. The system 200 provides the user with the information required for annotation, which allows even a person having no specialized knowledge to assign an annotation correctly. Accordingly, the restriction on selection of the operator can be alleviated. Consequently, securement of the operator is facilitated while the operation efficiency is improved. Accordingly, in comparison with the conventional art, a large amount of images can be efficiently annotated.

Note that in this embodiment, the example is described where the control apparatus 130 generate the classified image used for controlling the imaging device 100 and for supporting annotation. Alternatively, these may be performed separately by different apparatuses. For example, the control apparatus 130 may control the imaging device 100, and an apparatus different from the control apparatus 130 may generate the classified image. The apparatus different from the control apparatus 130 may display the classified image in response to a request by the user. The control apparatus 130 controls the imaging device 100 and generates the classified image. The apparatus different from the control apparatus 130 may display the classified image in response to a request by the user. The apparatus different from the control apparatus 130 is, for example, any of client terminals, which include a tablet, a smartphone, and a computer. These client terminals may be configured to be capable of communicate with the control apparatus 130. Likewise with the control apparatus 130, the client terminal may be what includes one or more processors, and one or more non-transitory computer-readable media.

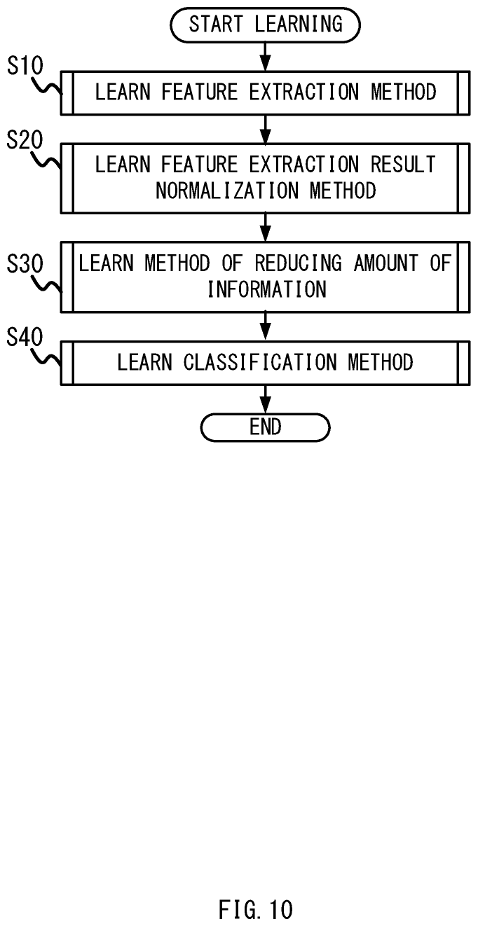

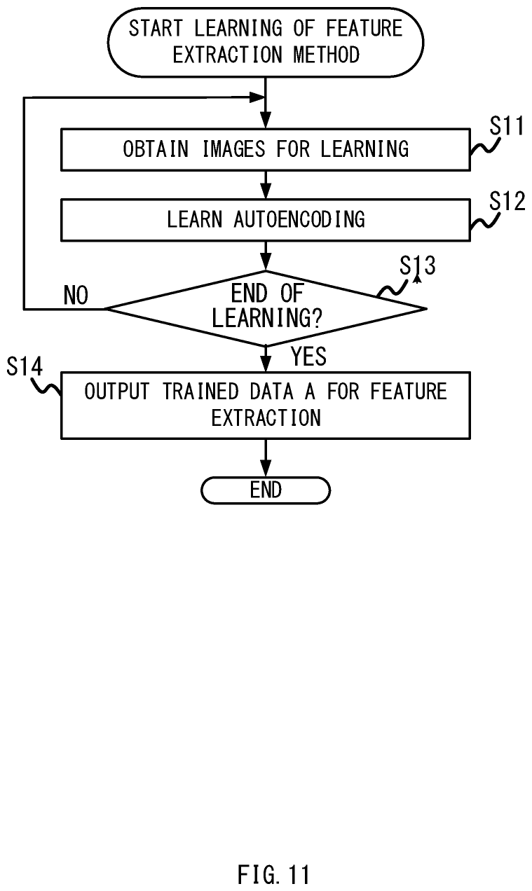

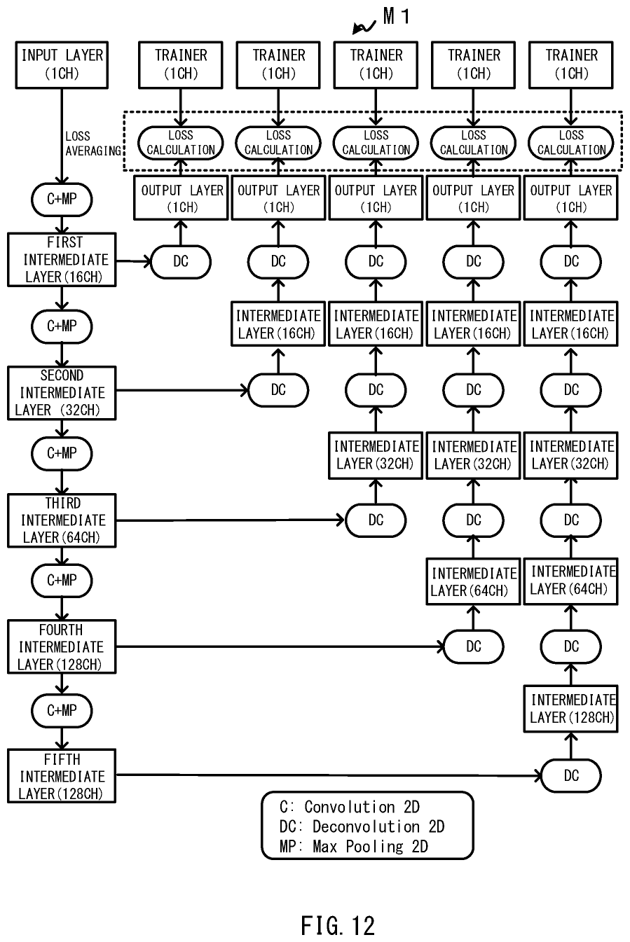

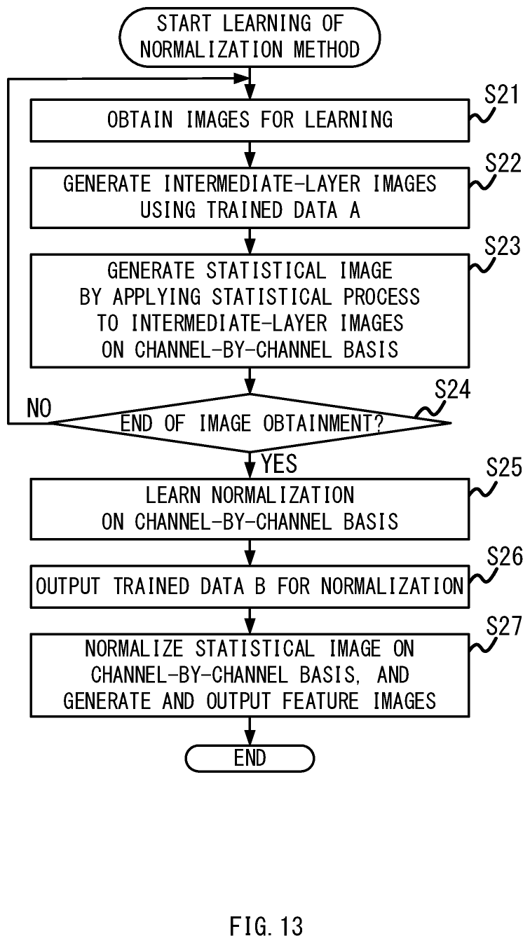

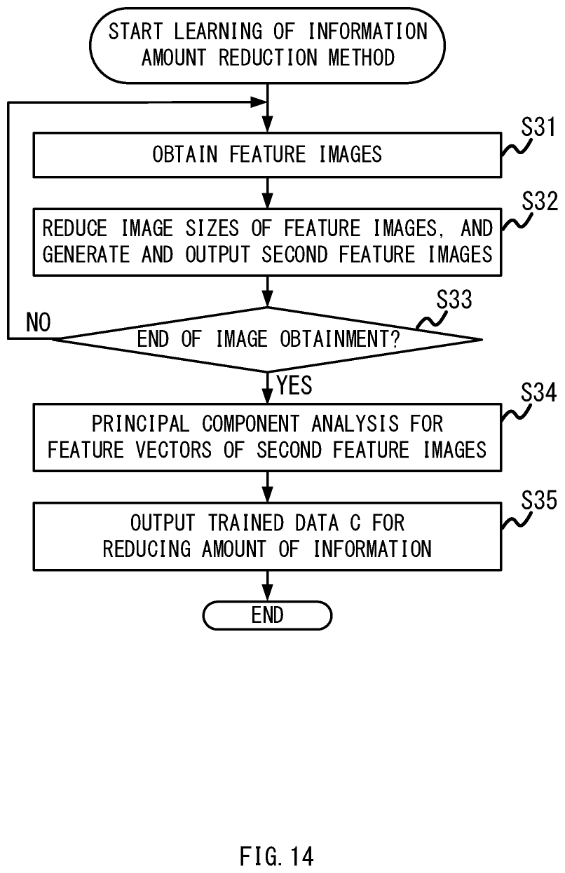

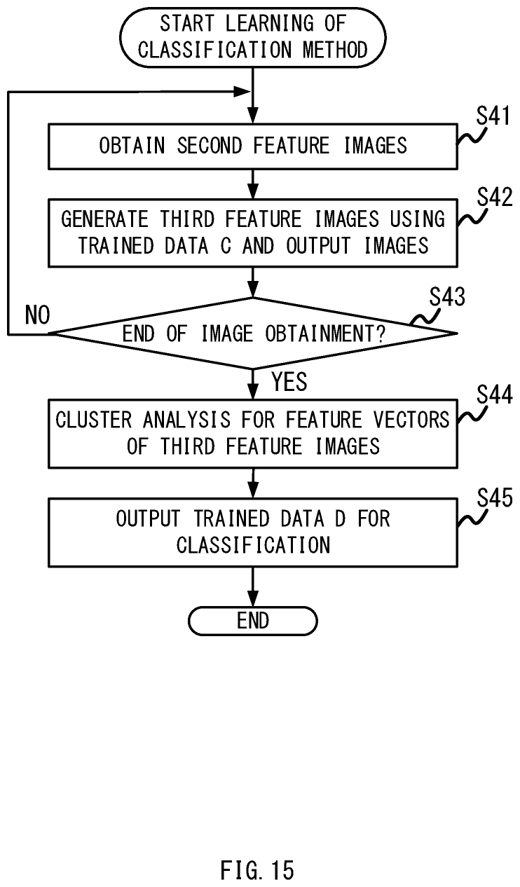

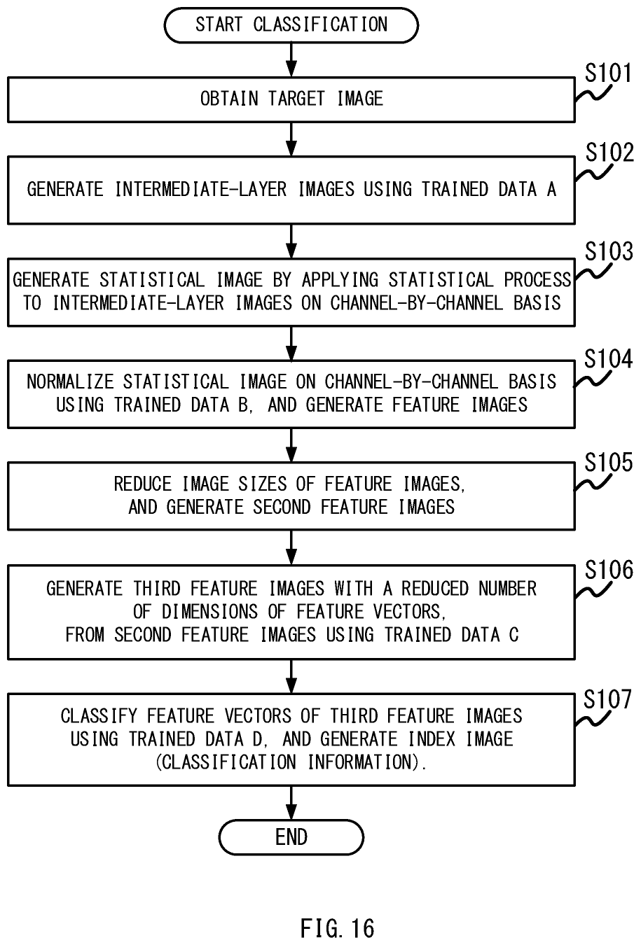

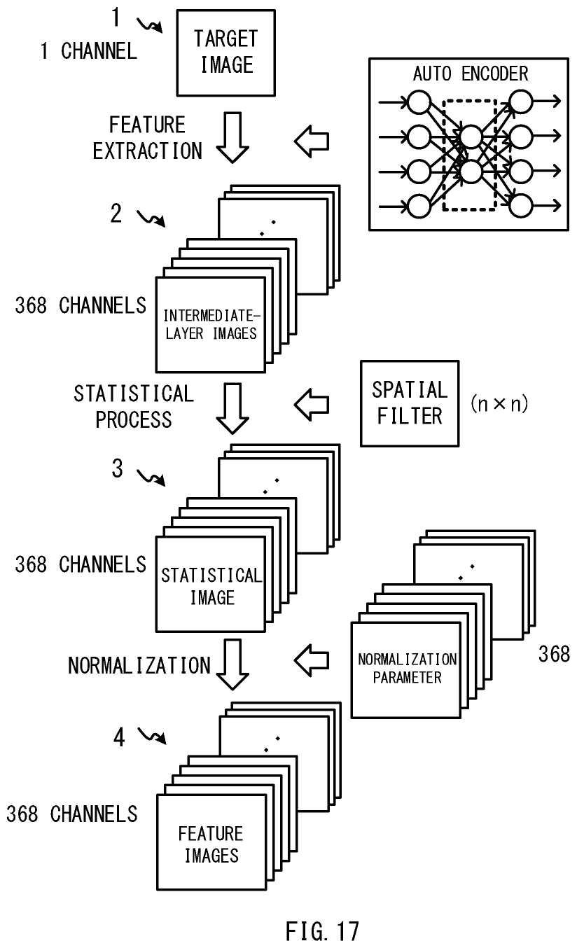

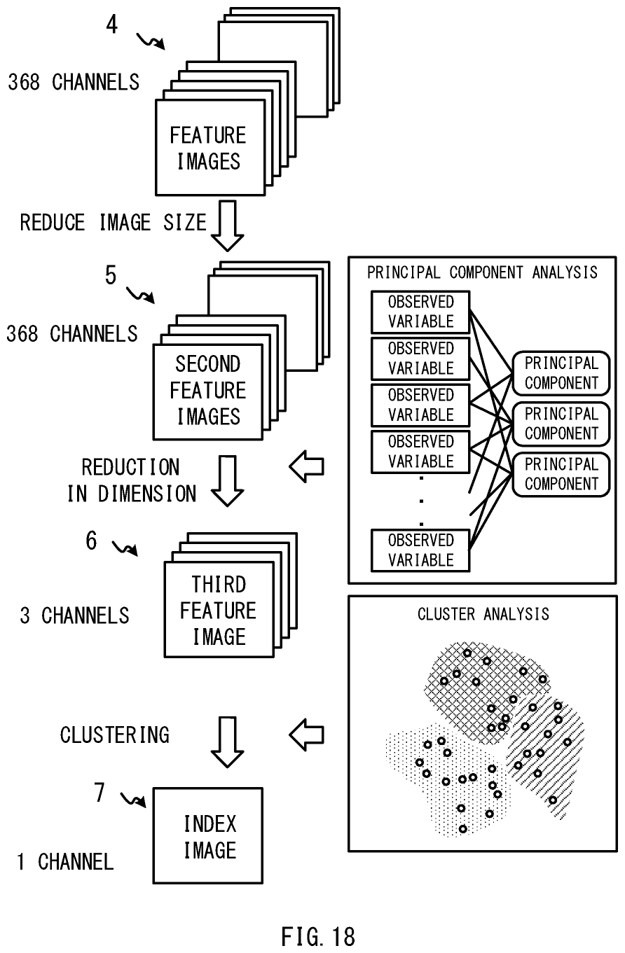

FIG. 10 is a flowchart showing an example of processes executed in a learning stage by the system 200. FIG. 11 is a flowchart showing an example of a learning process in a feature extraction method. FIG. 12 shows an example of a feature extraction model M1. FIG. 13 is a flowchart showing an example of a learning process in a normalization method. FIG. 14 is a flowchart showing an example of a learning process in an information amount reduction method. FIG. 15 is a flowchart showing an example of a learning process in a classification method. FIG. 16 is a flowchart showing an example of a classification process by the system 200. FIG. 17 exemplifies a former half of input and output in the classification process. FIG. 18 exemplifies a latter half of the input and output in the classification process. Hereinafter, referring to FIGS. 10 to 18, a classification process in step S2 of FIG. 5, and a learning process that is preliminarily performed to make the classification process executable are described in detail.

The classification process in step S2 of FIG. 5 described above is performed using trained data obtained through machine learning. First, referring to FIGS. 10 to 15, the learning process performed to obtain the trained data is described. Preferably, the learning process is performed for each target to be annotated. For example, in a case of annotation to the differentiated region and the undifferentiated region of iPS cells, it is preferable to perform learning using multiple images obtained by a process of culturing the iPS cells.

The learning process shown in FIG. 10 is performed by the control apparatus 130, for example. Alternatively, the process may be performed by an apparatus different from the control apparatus 130. The images used for learning are obtained by the imaging device 100, for example. The images may be obtained by the apparatus different from the imaging device 100. That is, only if the trained data obtained through learning by the apparatus that performs classification is used, the learning and classification may be performed by different apparatuses. Hereinafter, a case where the control apparatus 130 executes the learning process using the images of the cultured cells obtained as the images for learning by the imaging device 100 is exemplified and described.

The learning process shown in FIG. 10 includes: a process of learning a feature extraction method (step S10); a process of learning a method of normalizing a feature extraction result (step S20); a process of learning a method of reducing the amount of information (step S30); and a process of learning a classification method (step S40).

As shown in FIG. 11, in step S10 of learning the feature extraction method, first, the control apparatus 130 obtains the images for learning (step S11), and learns autoencoding through deep learning using the obtained images for learning (step S12). The control apparatus 130 repeats the processes in steps S11 and S12 for all the images for learning.

In step S12, the same images for learning are set for both input data and training data on the neural network, and the neural network is repetitively trained. That is, the neural network is trained using the multiple images for learning. An auto encoder that extracts features of images through the trained neural network is constructed. FIG. 12 shows a specific network configuration example. A model M1 shown in FIG. 12 is only one example. The number of channels and the number of layers can be appropriately changed. Note that FIG. 12 exemplifies an auto encoder that includes five intermediate layers. The learning in step S12 is performed so as to average total five loss functions in a case of using only one intermediate layer of the model M1 to a case of using all the five layers.

After the control apparatus 130 performs the processes in steps S11 and S12 for all the images for learning, this apparatus determines whether to finish learning or not (step S13). Here, the determination may be made based on whether the loss function is equal to or less than a reference value or not. When it is determined that the loss function is equal to or less than the reference value, the control apparatus 130 finishes the learning (YES in step S13), and outputs, as trained data, the auto encoder (hereinafter, described as trained data A for feature extraction) constructed in step S12 (step S14). Note that the trained data A may be the entire or a part of neural network (e.g., information on an input layer to the fifth intermediate layer) constituting the auto encoder.

In step S20 of learning the normalization method, as shown in FIG. 13, first, the control apparatus 130 obtains images for learning (step S21), and subsequently, generates intermediate-layer images using the trained data A obtained in step S10 (step S22).

In step S22, the control apparatus 130 inputs the images for learning into the model M1, and outputs, as intermediate-layer images, data on the intermediate layer where the images for learning are compressed and the feature is extracted, for example. Note that in a case where the data on the intermediate layer is not a two-dimensional array (image format) but is a one-dimensional array, the array is transformed into two-dimensional array (image format), which is output as the intermediate-layer images. For example, in a case where all the first to fifth intermediate layers of the model M1 are used, in step S22 total 368 (=16+32+64+128+128)-channel of intermediate-layer images are generated.

After the intermediate-layer images are generated in step S22, the control apparatus 130 applies a statistical process to the intermediate-layer images on a channel-by-channel basis, and generates a statistical image (step S23). Here, the statistical process is an image filtering process that performs a statistical operation. The statistical operation is an operation, such as of average or variance, for example. In other words, the statistical process is a spatial filtering process that uses information on an intended pixel and pixels adjacent thereto.

Note that the statistical operation performed in the statistical process in step S23 may be one type (e.g., only averaging), or two or more types (e.g., average and variance calculations). In a case where two or more types of statistical operations are performed, the control apparatus 130 may output the operation results respectively as different channels.

The control apparatus 130 repeats the processes in steps S21 and S23 for all the images for learning (NO step S24). After all the images for learning are processed (YES in step S24), the control apparatus 130 learns normalization on a channel-by-channel basis (step S25), and outputs the trained data (step S26).

In step S25, the control apparatus 130 extracts the maximum pixel value and the minimum pixel value as normalization parameters, from among the statistical images generated in step S23, on a channel-by-channel basis. In step S26, the control apparatus 130 outputs the extracted normalization parameters (hereinafter, described as trained data B for normalization) as the trained data.

Lastly, the control apparatus 130 normalizes the statistical images on a channel-by-channel basis using the trained data B for normalization, generates feature images, and outputs the generated feature images (step S27). Here, the control apparatus 130 transforms the statistical images using the trained data B, and generates feature images having pixel values ranging from zero to one.

In step S30 of learning the information amount reduction method, as shown in FIG. 14, first, the control apparatus 130 obtains the feature images (step S31). Subsequently, the control apparatus 130 reduces the image size of the feature image, generates a second feature image, and outputs the generated second feature image (step S32).

In step S32, the control apparatus 130 may reduce the image size by thinning out pixels from the feature image on the basis of a predetermined rule. The control apparatus 130 may reduce the image to that of a freely selected size, using interpolation.

The control apparatus 130 repeats the processes in steps S31 and S32 for all the feature images (NO step S33). After all the feature images are processed (YES in step S33), the control apparatus 130 applies principal component analysis to the feature vector of the second feature image having a reduced image size (step S34). Note that the principal component analysis may be performed after transforming the second feature image into a one-dimensional array as required.

The control apparatus 130 outputs, as trained data, a transformation matrix (hereinafter, described as trained data C for reducing the amount of information) for outputting principal components identified by the principal component analysis in step S34 in response to the input of the second feature image (step S35). Preferably, the number of principal components output by the transformation matrix is appropriately set depending on the complexity of the classification target. Preferably, the more complex the classification target is, the more the principal components remain.

In step S40 of learning the classification method, as shown in FIG. 15, first, the control apparatus 130 obtains the second feature image (step S41), and subsequently, generates third feature image using the trained data C obtained in step S30 (step S42). Note that the third feature image is an image that includes the principal components of the second feature image, and is an image having a lower number of dimensions (i.e., the number of channels) of the feature vector than the third feature image.

The control apparatus 130 repeats the processes in steps S41 and S42 for all the second feature images (NO step S43). After all the second feature images are processed (YES in step S43), the control apparatus 130 applies cluster analysis to the feature vector of the third feature image having a reduced number of dimensions (step S44).

For example, the K-means method or the like can be adopted as the cluster analysis applied in step S44. The K-means method is preferable in that the trained classification rule can be stored. However, the cluster analysis method is not limited to the K-means method. Note that the cluster analysis may be performed after transforming the third feature image into a one-dimensional array as required.

The control apparatus 130 outputs, as trained data, the classification rule (hereinafter described as trained data D for classification) created by the cluster analysis in step S44 (step S45). Preferably, the number of clusters (the number of classes) as a classification result is appropriately set depending on the classification target before the cluster analysis in step S44 is performed.

The system 200 stores, in the storage devices 132, the trained data 132b (trained data items A to D) obtained by the learning process described above. When the user performs annotation, the system 200 supports the user in annotation using these trained data items.

Next, referring to FIGS. 16 to 18, the classification process in step S2 of FIG. 5 is described in detail with consideration of how to use the trained data generated by the learning process shown in FIGS. 10 to 15.

First, the control apparatus 130 obtains the target image (step S101). Here, for example, in step S1, the control apparatus 130 obtains, as the target image, the image obtained by the imaging device 100 taking cells cultured in the vessel C. As shown in FIG. 17, the target image (image 1) is, for example, one (one-channel) image.

After the control apparatus 130 obtains the target image, this apparatus generates an intermediate-layer image using the trained data A (step S102). Here, the processors 131 input the intermediate-layer image, as the trained data A, into the auto encoder stored in the storage devices 132, and obtain the intermediate-layer data as the intermediate-layer image. As shown in FIG. 17, the intermediate-layer image (image 2) obtained by extracting feature of the target image (image 1) has, for example, the same number of channels as the number of channels on the intermediate layers.

After the intermediate-layer images are generated, the control apparatus 130 applies a statistical process to the intermediate-layer images on a channel-by-channel basis, and generates a statistical image (step S103). Here, the processors 131 apply a spatial filtering process to the intermediate-layer images, thereby generating a statistical image. Note that the spatial filtering process performed in this step is the similar to the process in step S23 of FIG. 13. As shown in FIG. 17, the statistical image (image 3) has the same number of channels as the intermediate-layer image (image 2).

After the statistical image is generated, the control apparatus 130 normalizes the statistical images on a channel-by-channel basis using the trained data B, and generates feature images (step S104). Here, the processors 131 transform the statistical images into feature images having pixel values ranging from zero to one, using the normalization parameters stored as the trained data B in the storage devices 132. Note that the normalization parameters are stored on a channel-by-channel basis. Accordingly, the normalization parameters associated with the channel of the statistical image in step S104 are used. As shown in FIG. 17, the feature image (image 4) has the same number of channels as the statistical image (image 3).

After the feature image is generated, the control apparatus 130 reduces the image size of the feature image, and generates the second feature image (step S105). Similar to the process in step S32 of FIG. 14, the processors 131 may herein reduce the image size by thinning out pixels according to a predetermined rule from the feature images, or reduce the size of the images to any size using interpolation. As shown in FIG. 18, the feature images (images 5) have the same number of channels as the statistical images (images 4).

After the second feature images are generated, the control apparatus 130 generate third feature images having a limitedly adjusted number of dimensions of the feature vectors, from the second feature images, using trained data C (step S106). Here, the processors 131 transform the second feature images into the third feature images made up of the principal components of the second feature images, using the transformation matrix stored as the trained data C in the storage devices 132. As shown in FIG. 18, the third feature images (images 6) has a smaller number of channels (three channels in this example) than the second feature images (images 5).

After the third feature images are generated, the control apparatus 130 classify the feature vectors (three dimensional in this example) of the third feature images using the trained data D, and generates an index image (classification information) (step S107). Here, the processors 131 cluster the feature vectors corresponding to multiple pixels constituting the third feature images, using the classification rule stored in the storage devices 132 as the trained data D. The processors 131 further two-dimensionally arrange the index (class information) indicated in the classified classes, and generates the index image. As shown in FIG. 18, the index image (index image 7) is, for example, one (one-channel) image, and is an example of the classification information described above.

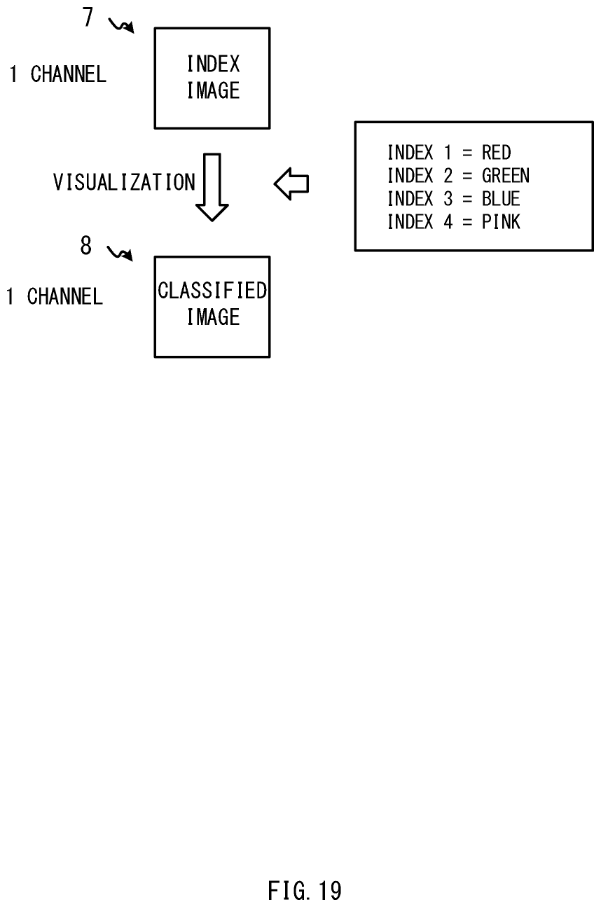

The system 200 stores, in the storage devices 132, the index image obtained by the classification process described above. When the user performs annotation, the system 200 generates the classified image obtained by visualizing the index image according to the indices as shown in FIG. 19, and arranges, on the screen, the image in a manner capable of comparison with the target image. Accordingly, the operator performing annotation can be supported.

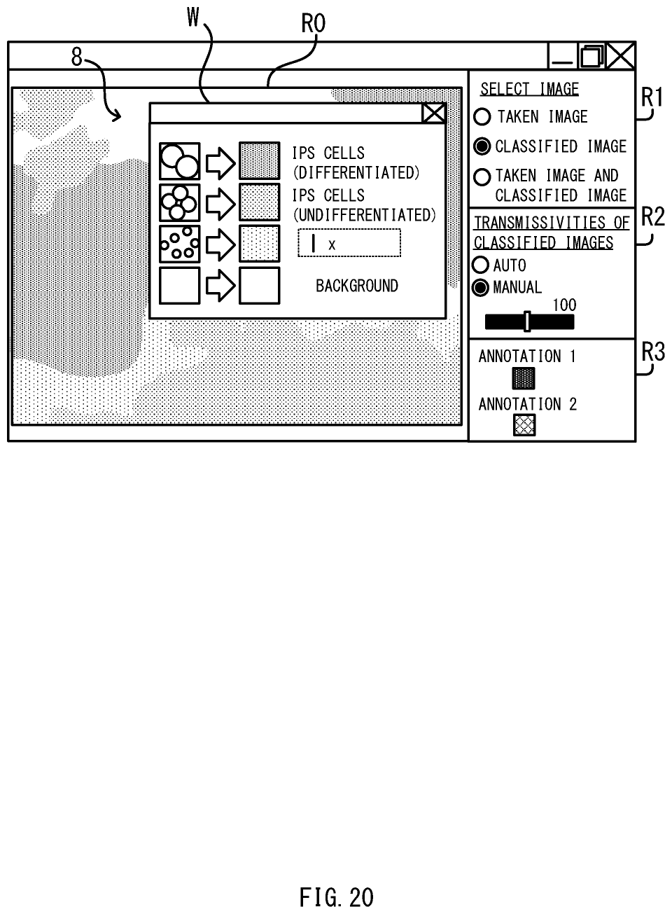

FIG. 20 shows still another example of an annotation screen. As shown in FIG. 20, the relationship between the classified image and the target image may be allowed to be verified on the annotation screen. In FIG. 20, by displaying a window W on the annotation screen, the relationships between the colors of the classified image and legends for regions in the target image that are classified into the respective colors are indicated on a class-by-class basis. Note that the number of legends for each class is not necessarily limited to one. Alternatively, multiple legends may be displayed. As shown in FIG. 20, in the window W, description on the target (or the class) indicated by the legend and the color can be input. For example, a skilled operator in this field inputs the description, thereby allowing an inexperienced operator to refer to the description input by the skilled operator. Accordingly, the classification in the classified image can be correctly grasped.

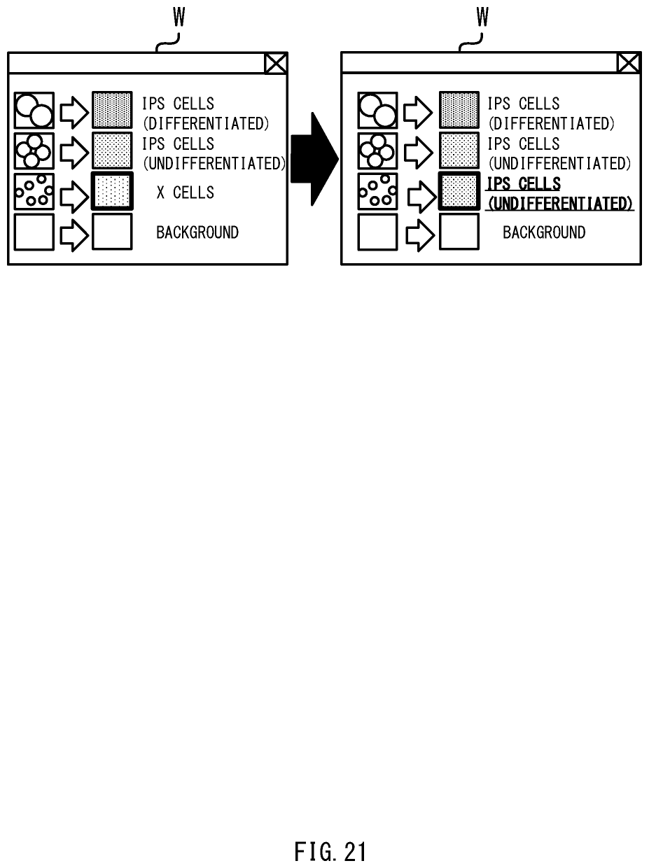

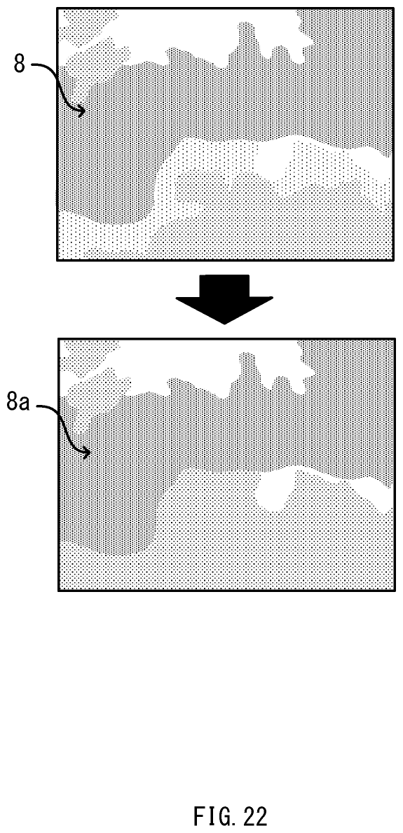

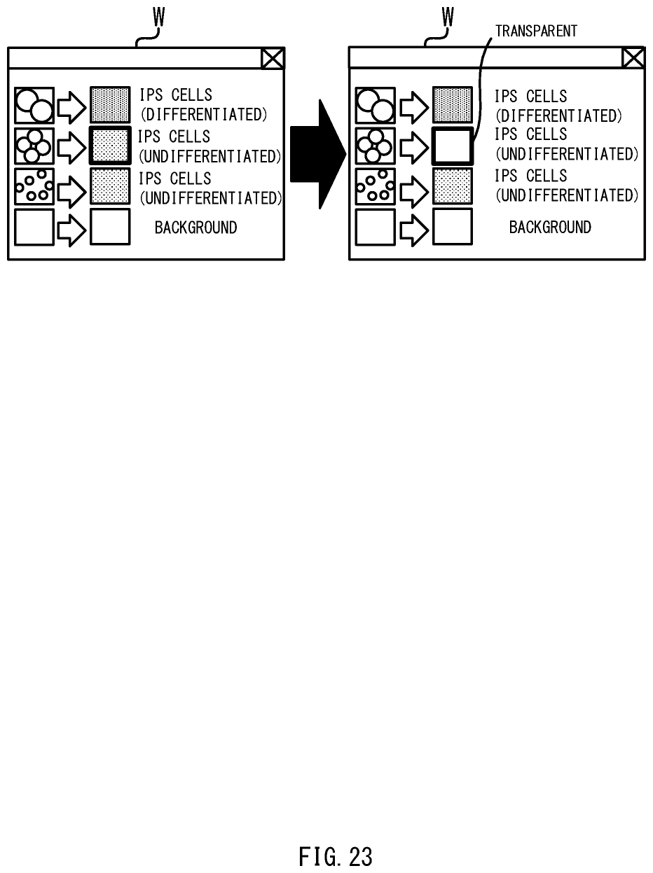

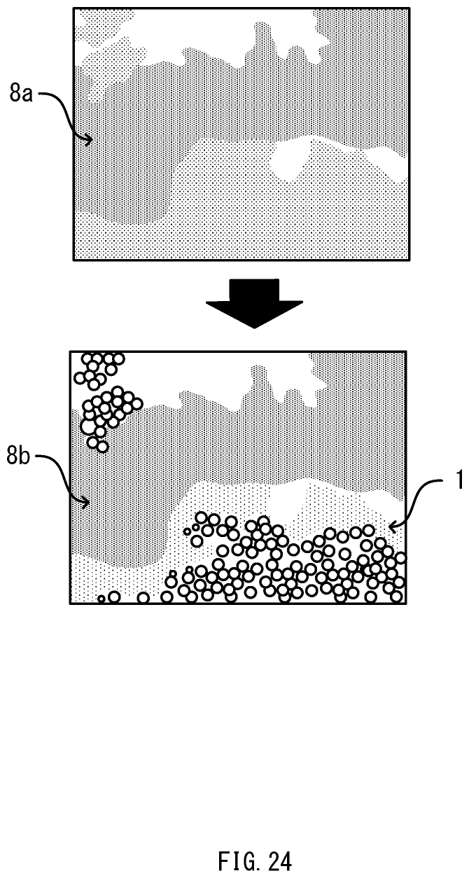

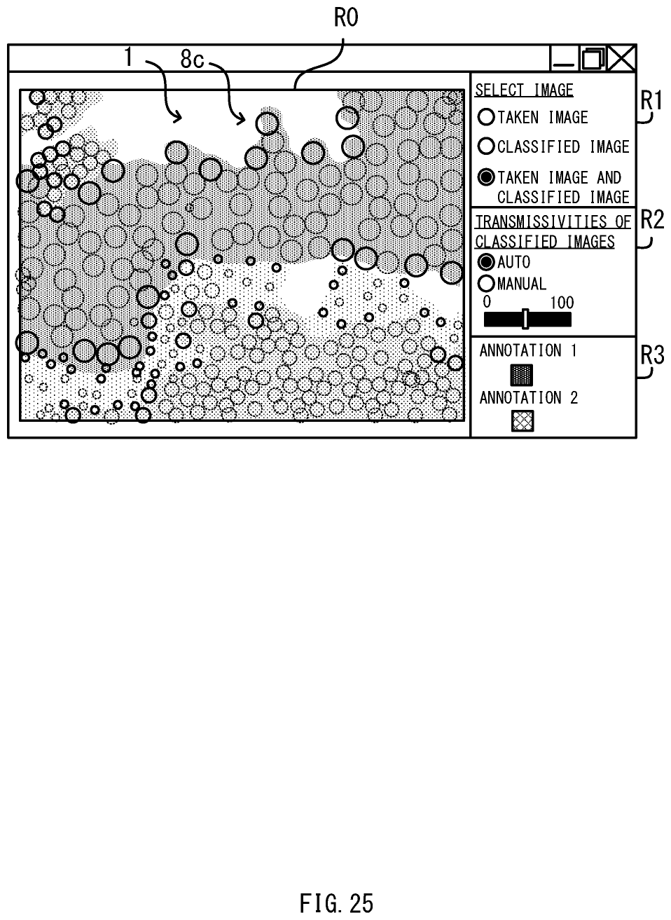

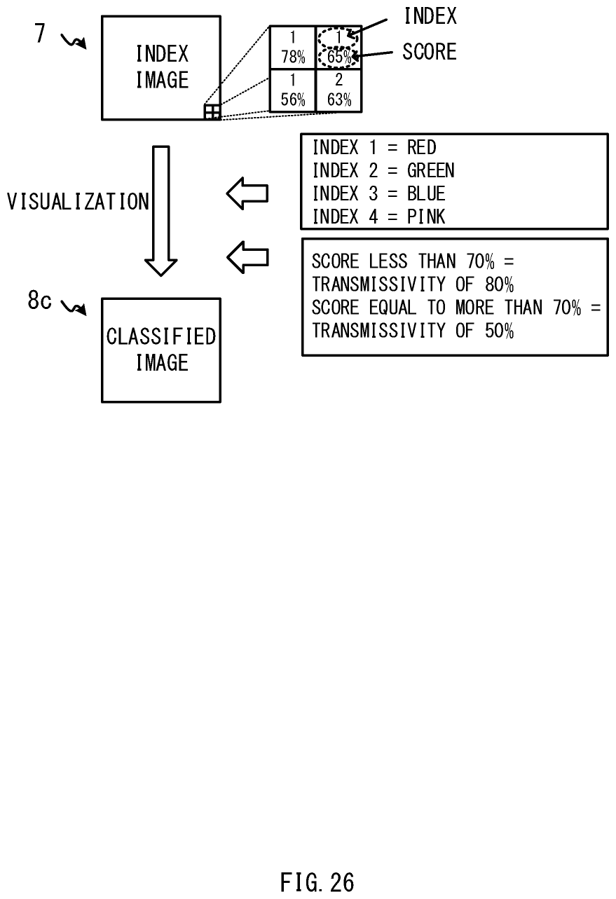

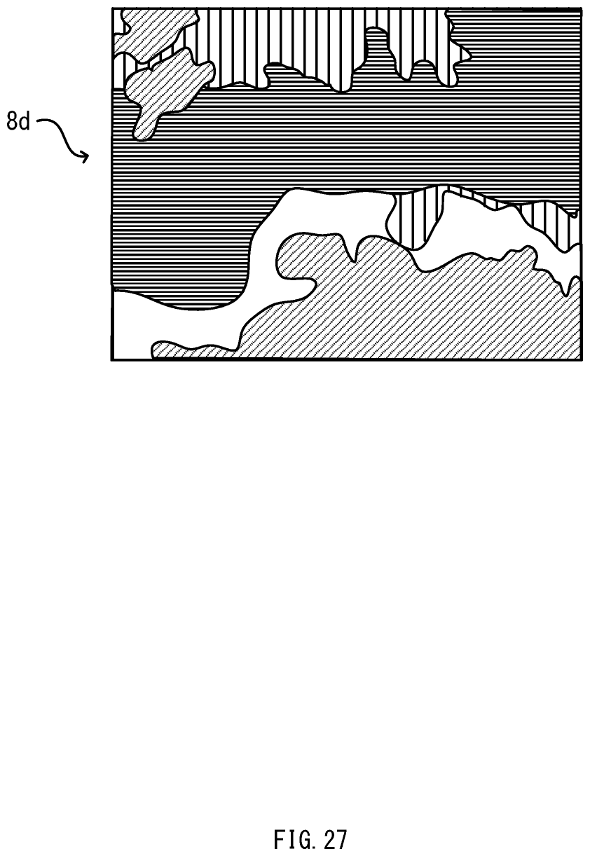

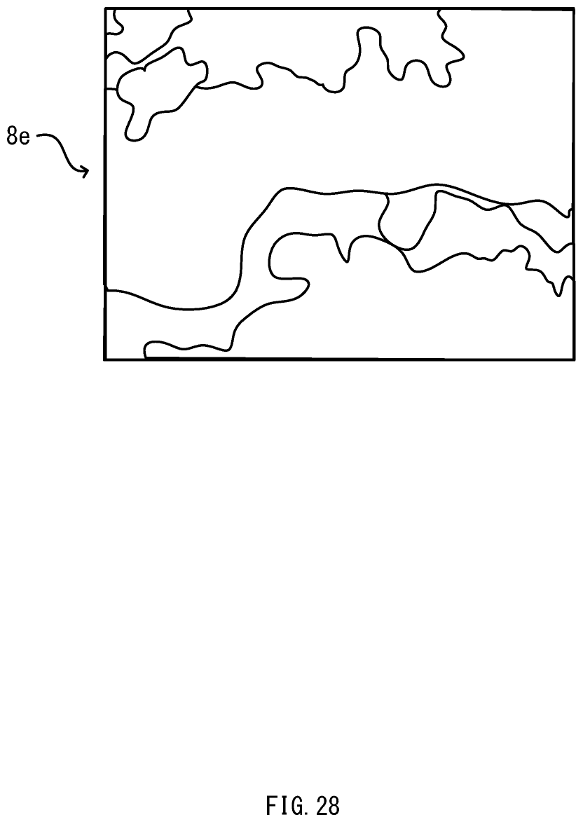

FIG. 21 is a diagram showing situations of changing colors to be assigned to a class. FIG. 22 exemplifies classified images before and after changing of color assignment shown in FIG. 21. FIG. 23 is another diagram showing situations of changing colors to be assigned to a class. FIG. 24 exemplifies classified images before and after changing of color assignment shown in FIG. 23. FIG. 25 shows still another example of an annotation screen. FIG. 26 is a diagram for illustrating a method of determining the transmissivity of the classified images. FIG. 27 shows another example of the classified image. FIG. 28 shows still another example of the classified image. The setting about visualization of the index image may be appropriately changed by the user. Hereinafter, referring to FIGS. 21 and 28, an example where the user changes the setting and changes the display mode for the classified image is described.

As shown in FIGS. 21 and 22, the control apparatus 130 may change the colors to be assigned to the classes according to an operation to the window W by the user. FIG. 21 shows an example where a color to be assigned to the third class is changed to the same color as a color to be assigned to the second class. Furthermore, the description of the third class is set to be common to the description of the second class in the example. In response to such an operation by the user, the control apparatus 130 may change the classified image to be arranged on the screen from the image 8 to an image 8a, as shown in FIG. 22. The image 8a is the classified image obtained by visualizing the index image according to the changed setting shown in FIG. 21, and is an image where the same color is assigned to the second and third classes. As described above, a person may adjust the classification by the system 200 to thereby construct an environment that facilitate annotation.

As shown in FIGS. 23 and 24, the control apparatus 130 may change the color to be assigned to the class to a transparent color according to an operation to the window W by the user. FIG. 23 shows an example where the color to be assigned to the second class is changed to the transparent color. In response to such an operation by the user, the system 200 may change the classified image to be arranged on the screen from the image 8a to an image 8b, as shown in FIG. 24. The image 8a is changed to the image 8b. Accordingly, the region classified into the class having the transparent color is changed to be transparent, and the target image (image 1) arranged under the classified image can be viewed. As described above, only the region classified into one or some classes is made transparent, and the state of the target (cells) can be verified in detail based on the actual image (target image).

As shown in FIGS. 21 to 24, the control apparatus 130 may change the display mode to be assigned to the class information in the classified image, according to a predetermined instruction (e.g., an operation by the user).

FIGS. 23 and 24 show the example of changing the transmissivities of the classified images on a class-by-class basis. Alternatively, the system 200 may change the transmissivities of the classified images on a region-by-region basis. As shown in FIGS. 25 and 26, the control apparatus 130 may automatically determine the transmissivities of the classified images on the basis of the reliability of the classification. FIG. 25 shows an example where the control apparatus 130 automatically updates the transmissivities of the classified images to be superimposed on the target image on a region-by-region basis, according to a predetermined instruction by the user (e.g., an operation of selecting “AUTO” in the region R2). Note that the transmissivity of the classified image 8c shown in FIG. 25 is determined depending on the reliability of the classification, for example.

To achieve such a transmissivity depending on the reliability, as shown in FIG. 26, when the index image (classification information) is generated, the reliability of the classification, i.e., score information indicating a stochastic score for the classification into the class may be output on a region-by-region basis, together with the index (class information). Consequently, the class information may include class information indicating the classified class, and the score information indicating the stochastic score for the classification into the class, with respect to each of the target regions. For example, in the case where the K-means method is used for the cluster analysis during index image generation, the control apparatus 130 may output the distance from the barycenter of the cluster (or information obtained by normalizing the distance) may be output as the stochastic score.

Since the classification information includes the score information, the control apparatus 130 may determine the transmissivities of the multiple classified regions constituting the classified image, on the basis of the score information of the corresponding target region among the target regions. More specifically, when the stochastic score is low, the transmissivity is set to be high, which allows the state of actual cells to be more finely verified on the target image with respect to regions having low classification reliabilities. On the other hand, for the regions on which classification having high reliabilities have been made, annotation can be performed on the basis mainly of information on the classified image. Note that FIG. 26 shows the example of adjusting the transmissivity of each region of the classified image, with a score of 70% being adopted a threshold.

The example where the classification information is visualized using the difference in color has been described above. However, various methods can be adopted as the color assigning method. For example, the index may be assigned to H (hue) in the HLS color space. Alternatively, a color that the people can easily identify may be selected, and the selected color may be assigned the index. Further alternatively, without any limitation to the example described above, any color may be assigned an index in conformity with the purpose.

The classification information may be visualized using the shading of color instead of the difference in color. Furthermore, the classification information may be visualized using the pattern. For example, as shown in FIG. 27, the control apparatus 130 may arrange, on the screen, an image 8d where the regions are visualized using the patterns different on a class-by-class basis as a classified image.

The example where the classification information is visualized by filling the regions with specific colors or patterns has been described above. However, it is only required that the classification information can be divided such that the regions with different classifications can be discriminated from each other. For example, visualization may be achieved by drawing the contours of the regions, instead of filling of the regions. For example, as shown in FIG. 28, the control apparatus 130 may arrange an image 8e where the contours of the regions classified into the same class are drawn, as a classified image, on the screen. The contours may be drawn with lines with different colors on a class-by-class basis, may be drawn with lines with different thicknesses on a class-by-class basis, may be drawn with lines with different line types on a class-by-class basis, or drawn with combinations thereof.

### Second Embodiment

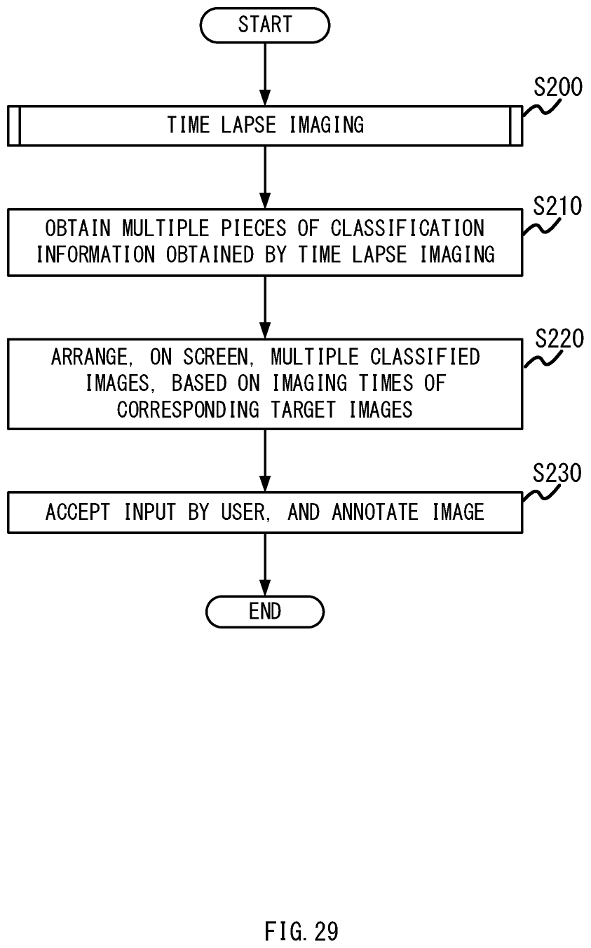

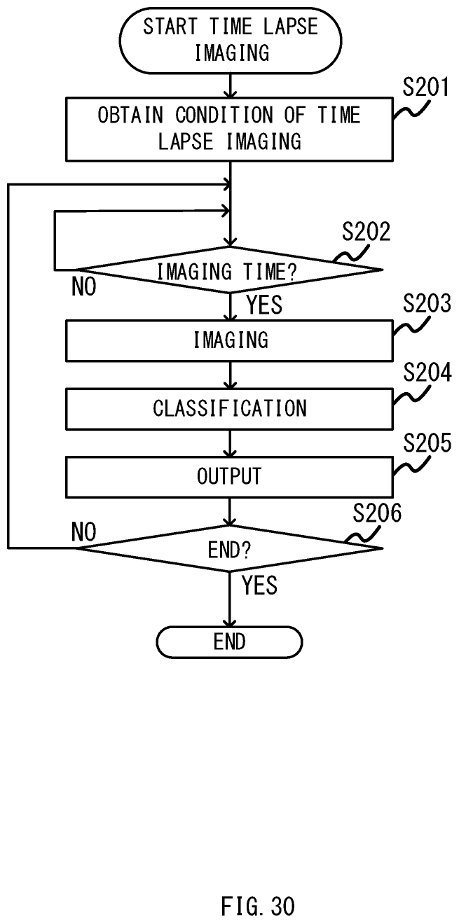

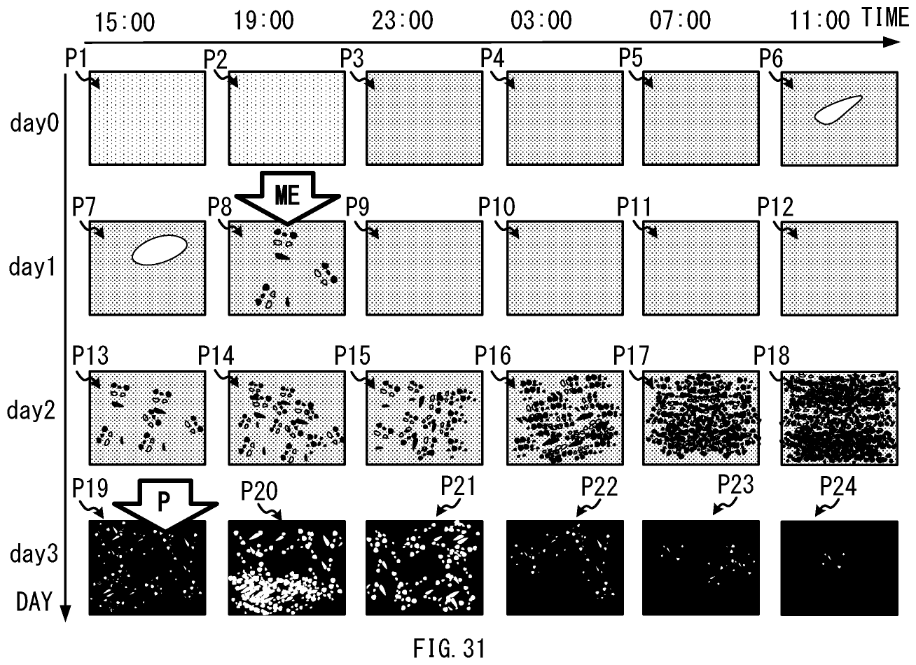

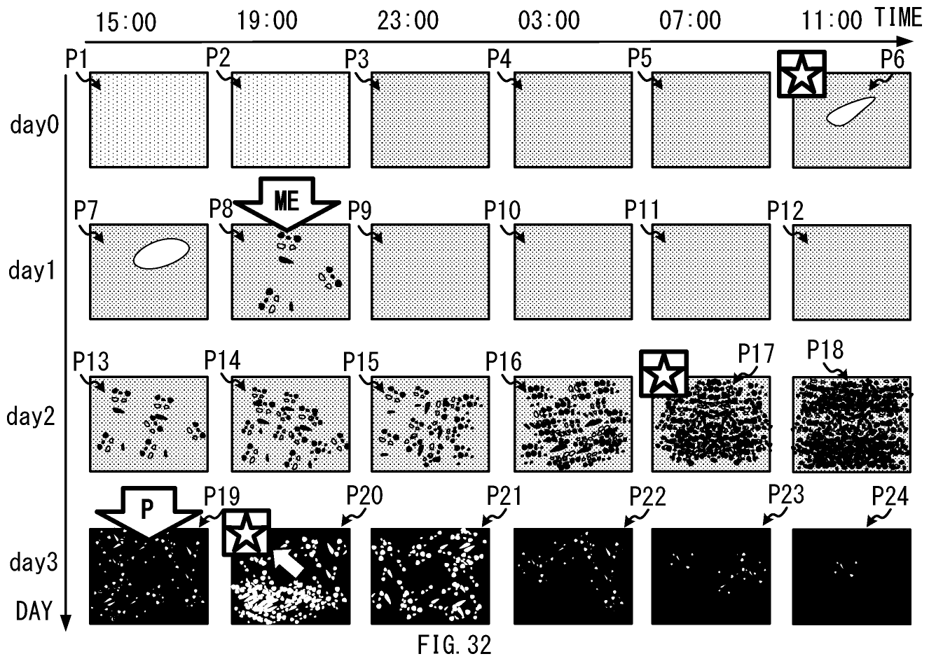

FIG. 29 is a flowchart showing an example of processes executed by the system according to this embodiment. FIG. 30 is a flowchart showing an example of a time lapse imaging process. FIGS. 31 and 32 show other examples of classified images arranged in a time-series order. Hereinafter, referring to FIGS. 29 to 32, processes performed by a system according to this embodiment are described. The processes shown in FIG. 29 are started by the processors 131 executing the program 132a.

Note that the system according to this embodiment supports selection of images to be annotated, by performing the processes shown in FIG. 29. The system according to this embodiment (hereinafter simply described as the system) is different, in performing the processes shown in FIG. 29 in addition to or instead of the processes shown in FIG. 5, from the system 200 according to the first embodiment. However, the system is similar to the system 200 in other points.

After the processes shown in FIG. 29 are started, first, the system performs time lapse imaging (step S200). Specifically, as shown in FIG. 30, the control apparatus 130 obtains conditions for time lapse imaging, such as the imaging time, and imaging position (step S201). When the imaging time is reached (YES in step S202), this apparatus transmits an imaging instruction to the imaging device 100 (step S203). The imaging device 100 having received the imaging instruction from the control apparatus 130 performs imaging according to the imaging instruction, and transmits an obtained target image to the control apparatus 130. For example, the control apparatus 130 having received the target image performs the classification process shown in FIG. 16 (step S204), and outputs the classification information generated by the classification process (step S205). The control apparatus 130 repeats the processes described above until the finish time of the time lapse imaging is reached (YES in step S206).

After the time lapse imaging is finished, the control apparatus 130 obtains multiple pieces of classification information obtained by the time lapse imaging (step S210). Note that the multiple pieces of classification information obtained here correspond to multiple target images taken at times different from each other.

Subsequently, the control apparatus 130 generates multiple classified images where the obtained pieces of classification information are visualized. A shown in FIG. 31, the generated classified images are arranged on the screen, on the basis of the imaging times of the target images corresponding to the respective classified images (step S220).

FIG. 31 shows situations where multiple classified images (images P1 to P24) are arranged in a time-series order. Specifically, in FIG. 31, the classified images generated based on the target images taken every four hours from 15:00 on the first day are arranged in the order of imaging time.

An arrow assigned “ME” indicates that media have been replaced. An arrow assigned “P” indicates passage has been performed. Information about the time when the medium replacement or passage is performed is recorded by the operator pressing an operation button provided on the imaging device 100. The control apparatus 130 may display content indicating timings of medium replacement and passage, together with the classified images, on the basis of the time information recorded in the imaging device 100. The medium replacement and passage largely change the culture environment. Accordingly, it is beneficial, for selection of an annotation image, to provide information so as to demonstrate when these are performed.

FIG. 32 shows situations where the user selects an image to be annotated from among classified images arranged based on the imaging times. In this example, three images, or images P6, P17 and P19, are selected. In the middle of a step where the user actually assigns an annotation, not only an image to be annotated but also display content indicating that the image has already been annotated by the user may be displayed. Specifically, a mark may be displayed at the imaging time when the image is assigned one or more annotations. A mark may be displayed for the annotated image. Accordingly, the effort of the annotation operation can be further reduced.

After multiple classified images are arranged on the screen, the system accepts an input by the user, and annotates the image (step S230). Note that the process of step S230 is similar to the process in step S4 of FIG. 5.

By performing the processes shown in FIG. 29, the system can support selection of the image to be annotated by the user. Hereinafter, this point is specifically described.

To achieve a high learning efficiency with a relatively small number of images in machine learning, it is preferable that the training data created by annotation include a wide variety of images. The system according to this embodiment arranges, on the screen, multiple classified images on the basis of the imaging times. Consequently, the user can easily grasp the change occurred in the target image, by comparing the classified images with each other. For example, the user can select a wide variety of images only by selecting images according to a reference of prioritizing a largely changed image. Accordingly, the user can easily and appropriately select the image to be annotated. In particular, the user can grasp the change caused in the image at a glance, not by displaying the target image in an arranged manner, but by displaying the classified images in an arranged manner instead. Consequently, the image to be annotated can be selected in a short time period, which increases the operation efficiency of annotation. By combining the annotation support methods according to the first embodiment, consistent supports are provided for selection of the image to be annotated to the operation of annotation. Accordingly, the user can assign annotations further efficiently.

Note that the description has been made with the example where after the time lapse imaging is finished, the image to be annotated is selected. Alternatively, the selection of the image to be annotated may be performed during the time lapse imaging period. The classified images created from the image having already obtained by the control apparatus 130 may be displayed in a time-series manner, which may allow the user to select the image to be annotated as needed.

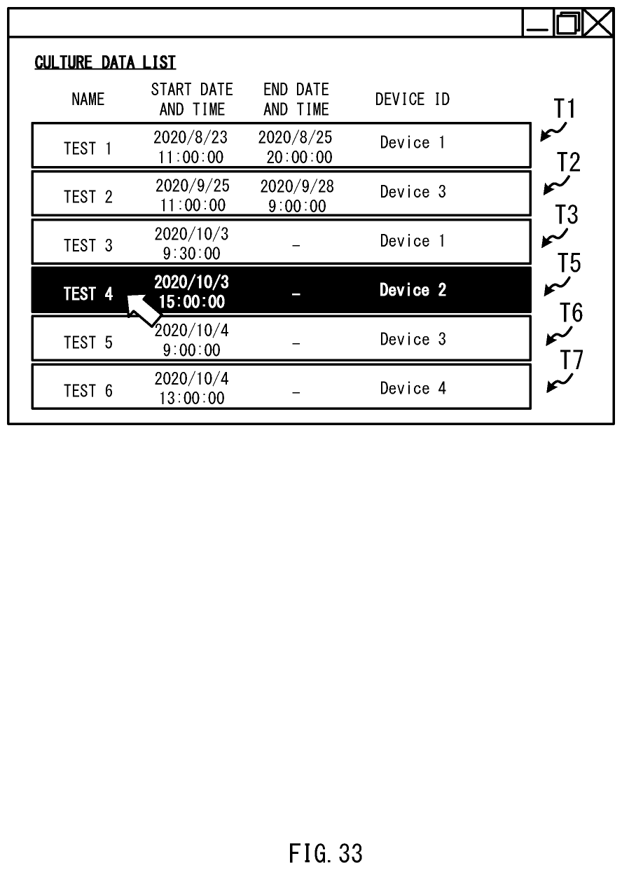

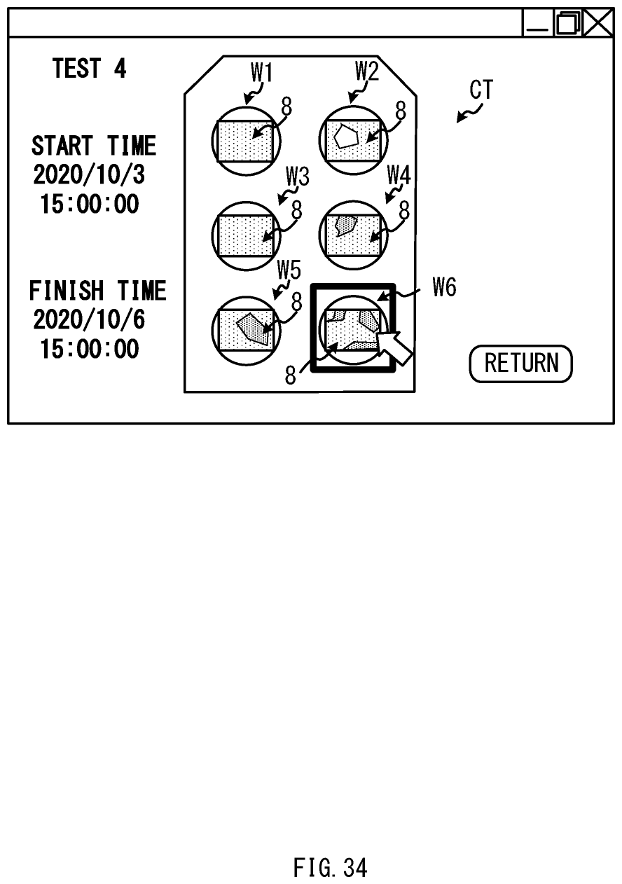

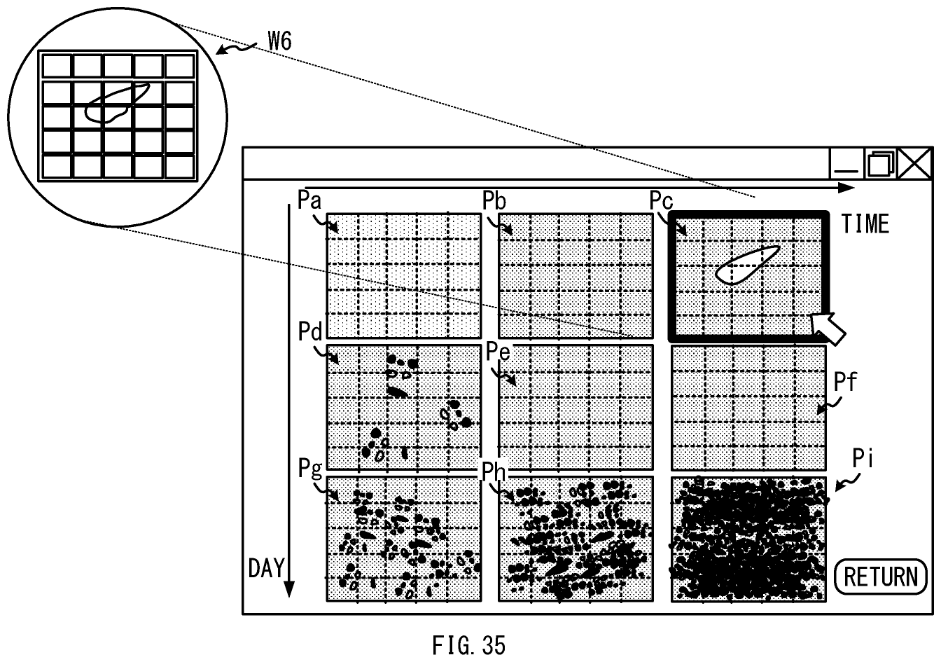

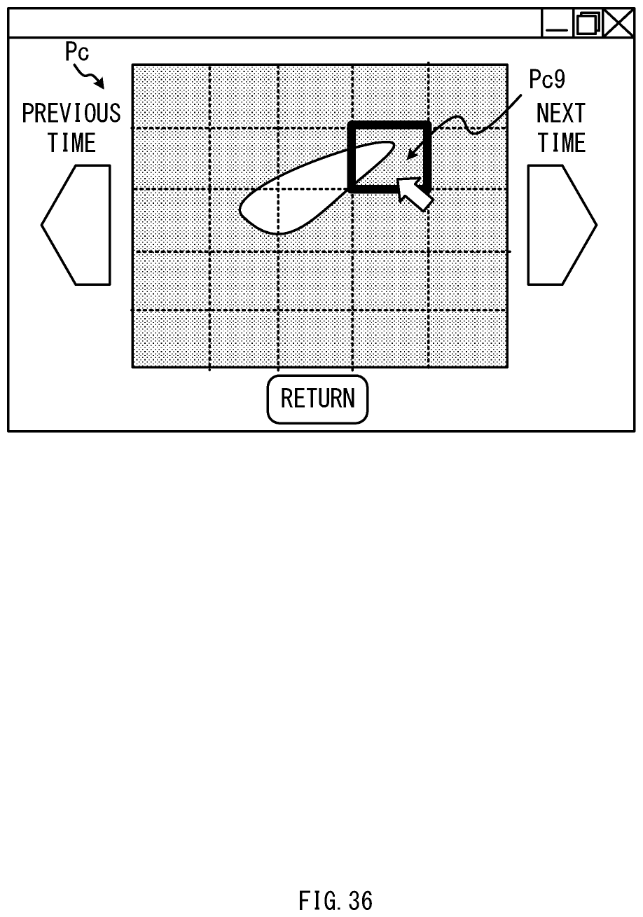

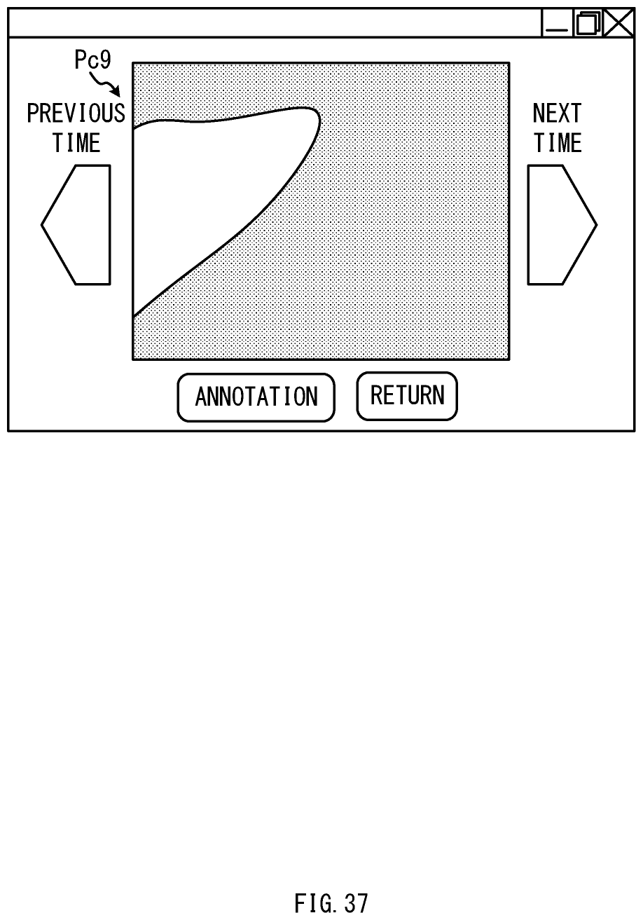

FIG. 33 shows an example of culture data list screen. FIG. 34 shows an example of a culture data top screen. FIG. 35 shows an example of time-series display screen. FIG. 36 shows an example of a pasted image display screen. FIG. 37 shows an example of a pasted element image display screen. Hereinafter, referring to FIGS. 33 to 37, an example of screen transition to selection of the image to be annotated is specifically described.

As shown in FIG. 33, first, the control apparatus 130 displays, on the display device 134, a list of culture data items obtained by time lapse imaging, and allows the user to perform selection. The culture data may include data on ongoing time lapse imaging. FIG. 33 shows situations where “TEST 4” that is culture data on ongoing time lapse imaging in the device ID “Device 2” is selected by the user.

After the culture data is selected, the control apparatus 130 arranges a vessel image (image CT) simulating a culture vessel on the screen of the display device 134. Furthermore, the control apparatus 130 may arrange, on the vessel image, the classified images based on the target image obtained by taking the specimen in the vessel. The classified images may be arranged on the vessel image on the basis of the imaging position of the target image on the culture vessel.

FIG. 34 shows an example where the culture vessel is a multi-well plate. A vessel image (image CT) simulating the multi-well plate includes well images W1 to W6 respectively simulating multiple wells. The control apparatus 130 may arrange multiple classified images (images 8) corresponding to the target images obtained by taking cells in the corresponding wells, at positions corresponding to the well images.

As shown in FIG. 34, in a case where the culture vessel is a vessel that includes, for example, multiple culture regions, such as a multi-well plate, it is preferable to arrange classified images representing the states of the culture regions with respect to the respective culture regions. Accordingly, the states of the culture regions can be grasped by the user at a glance, which facilitates selection of culture regions to be verified further specifically. More preferably, the classified images are the classified images corresponding the latest target images.

When the culture region (e.g., the well image W6) is selected on the vessel image, the control apparatus 130 arranges, on the screen, the classified images generated based on the target images taken in the culture regions according to the imaging times, as shown in FIG. 35. Note that images Pa to Pi shown in FIG. 35 are classified images obtained by pasting together 5×5 target images taken by imaging the insides of the wells through scanning.

Furthermore, when a specific classified image (pasted image) is selected from among the classified images (pasted images) arranged in a time-series manner, the control apparatus 130 displays the selected classified image (the image Pc that is a pasted image) in an enlarged manner, as shown in FIG. 36. Note that if a classified image (pasted image) corresponding to a different time is intended to be displayed, it is only required to press any of buttons arranged at the left and right of the classified image.

Subsequently, when a region intended to be observed specifically in detail in the classified image (the image Pc) is selected, the control apparatus 130 displays the classified image (the image Pc9 that is a pasted element images) including the selected region, in an enlarged manner as shown in FIG. 37. The user verifies the sufficiently enlarged classified image (image Pc9), and determines whether or not to annotate the corresponding target image. Upon detection of a predetermined operation (e.g., pressing of an “ANNOTATION” button) by the user, the control apparatus 130 causes the screen to transition to the annotation screen.

As described above, the system according to this embodiment can support selection of the images performed by the user until transition to the annotation screen, using the time-series display of the classified images. Accordingly, the user can select an appropriate image. Accordingly, they can avoid image reselection and the like, and efficiently perform annotation.

Note that in this embodiment, the example of displaying only the classified image until transition to the annotation screen has been described. Alternatively, for selecting the image to be annotated, the target image may be used in addition to the classified image. For example, similar to the first embodiment, the classified image and the target images may be displayed in a superimposed manner, or the classified images and the target images may be displayed in a switchable manner. That is, the multiple classified images may be arranged on the screen in a time-series order in a manner capable of comparison with the target images.

In this embodiment, the example of listing the classified images at the imaging times of taking images in a time-series order has been described. However, not all the classified images at the imaging times of taking the images are necessarily displayed. For example, images that the user intend not to display may be selected on the screen shown in FIG. 32. For example, the user may select images whose changes are smaller than those of adjacent images, as images not to be displayed. The system may omit displaying of the images selected according to the selection by the user. The image to be listed may be narrowed down based on this omission. By limitedly adjusting the number of images to be listed, listing perspicuity is improved, which facilitates comparison between the images. Accordingly, the user can further easily select the image to be annotated.

### Third Embodiment

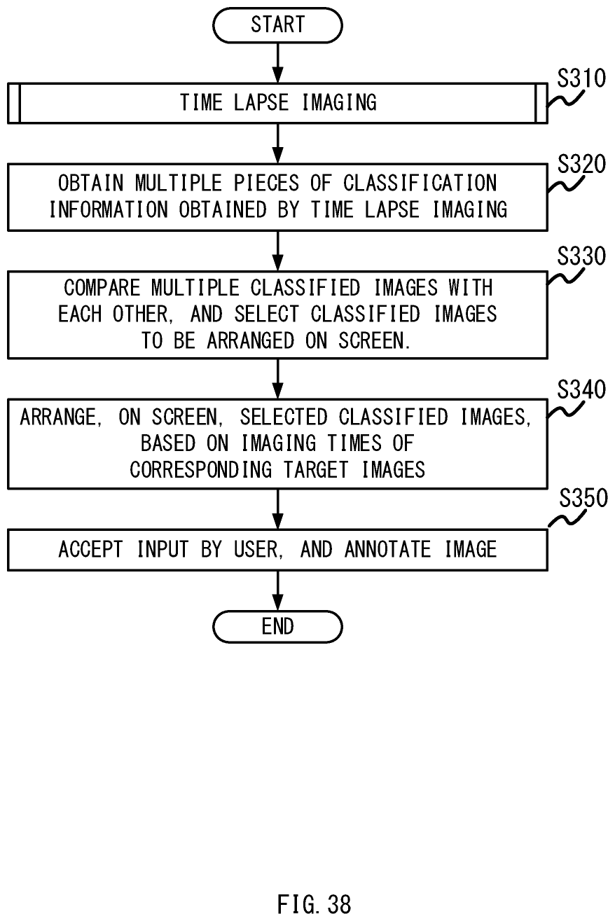

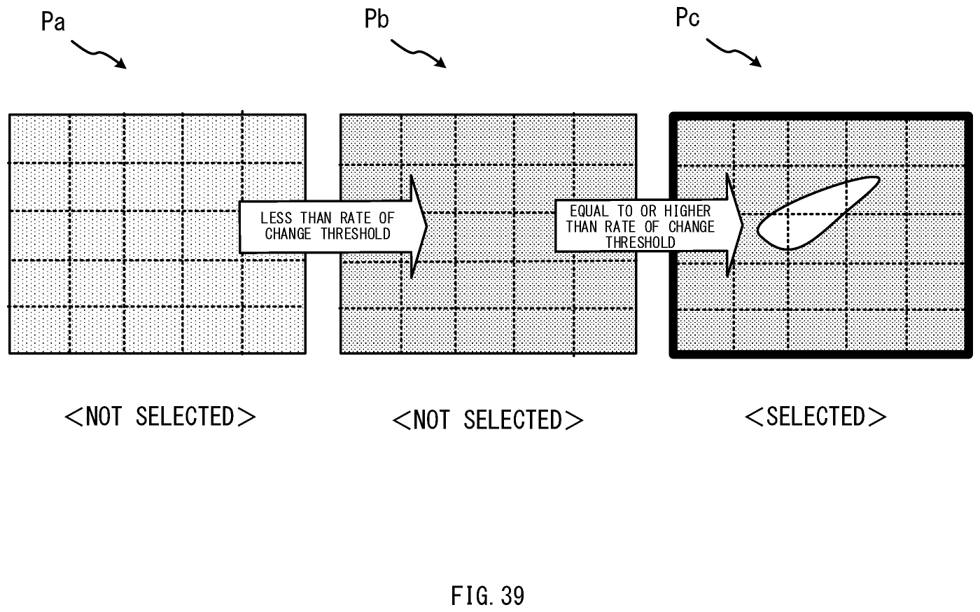

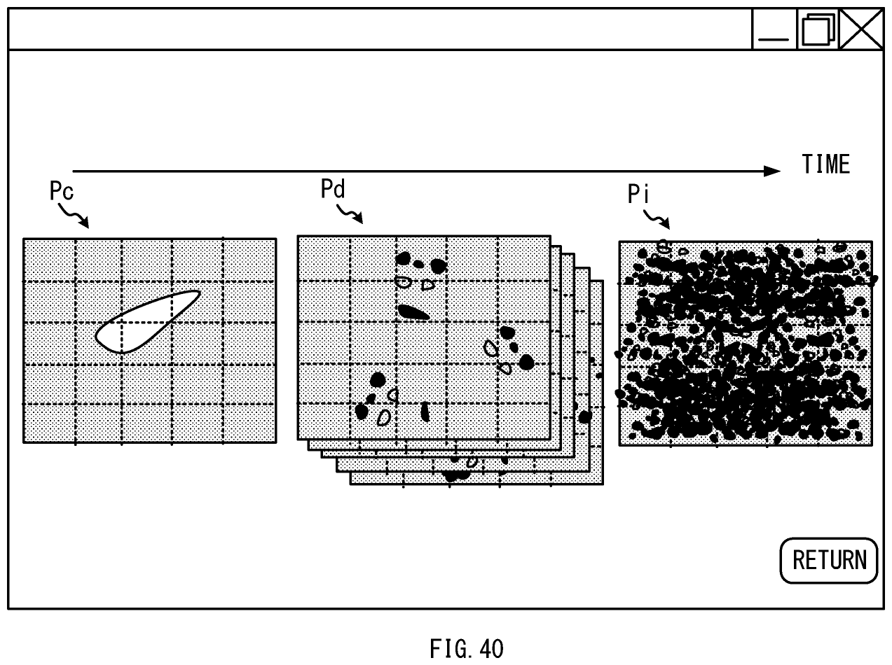

FIG. 38 is a flowchart showing an example of processes executed by the system according to this embodiment. FIG. 39 is a diagram for illustrating a method of selecting a classified image. FIG. 40 shows another example of classified images arranged in a time-series order. Hereinafter, referring to FIGS. 38 to 40, processes performed by a system according to this embodiment are described. Note that the system according to this embodiment supports selection of images to be annotated, by performing the processes shown in FIG. 38. The system according to this embodiment (hereinafter simply described as the system) is different, in performing the processes shown in FIG. 38 instead of the processes shown in FIG. 29, from the system according to the second embodiment. However, the system is similar to the system according to the second embodiment in other points. Note that the processes shown in FIG. 38 are started by the processors 131 executing the program 132a.

After the processes shown in FIG. 38 are started, first, the system performs time lapse imaging (step S310), and obtains multiple pieces of classification information obtained by the time lapse imaging (step S320). Note that the processes in steps S310 and S320 are similar to the processes in steps S200 and S210 of FIG. 29.

Subsequently, the control apparatus 130 selects multiple classified images to be arranged on the screen on the basis of comparison between the pieces of classification information obtained in step S320 (step S330). Here, the control apparatus 130 is only required to select largely changed images with priority. There is no limitation to a specific selection method. For example, as shown in FIG. 39, the control apparatus 130 may calculate the rate of change between every adjacent images among the classified images (images Pa, Pb, Pc, . . . ) arranged in a time-series manner, and select the classified images having a rate of change equal to or higher than a threshold (the image Pc in this example). For example, the control apparatus 130 may select the image (e.g., the image Pc) to be selected next on the basis of the rate of change relative to the selected image (e.g., the image Pa), instead of selecting the image on the basis of the rates of changes of the adjacent images.

When the multiple classified images are selected, the control apparatus 130 arranges, on the screen, the selected classified images on the basis of the imaging times of the target images corresponding to the respective classified images (step S340). Note that the process in step S340 is similar to the process in step S220 of FIG. 29 except for the point in that only the classified images selected in step S330 are arranged on the screen instead of arranging all the classified images obtained by the time lapse imaging on the screen.

FIG. 40 shows situations where multiple classified images (images Pc, Pd and Pi) selected in step S330 are arranged in a time-series order. Note that the images having not been selected in step S330 may be completely removed from the screen, or arranged so as to be hidden behind similar images as shown in FIG. 40.

After the selected classified images are arranged on the screen, the system accepts an input by the user, and annotates the image (step S350). Note that the process of step S350 is similar to the process in step S4 of FIG. 5.

By performing the processes shown in FIG. 38, the system can support selection of the image to be annotated by the user. In particular, according to this embodiment, the change of the target image is automatically detected based on comparison between the classified images. Based on the magnitude of change, the classified images to be arranged on the screen are automatically selected. Accordingly, even when image to be annotated are selected from among a large amount of images, omission of displaying similar images can reduce the number of images to be verified by the user, thereby allowing the load on the user to be significantly reduced. Furthermore, displaying the similar images is omitted, which can avoid unintentional annotation only to similar images, and can create training data having a high learning efficiency.

In this embodiment, the example of automatically selecting the classified images to be arranged on the screen on the basis of the magnitude of change is described. This selection is not necessarily performed by automatic selection by the system. For example, even without automatic selection by the system, the user can visually grasp the amount of change in each time period only if multiple classified images are displayed in a time-series order. Accordingly, as described above in the third embodiment, the user is only required to only annotate images determined to have a large amount of change. Images that do not serve as candidates of images to be annotated may be manually selected to be hidden. According to this embodiment, the rate of change between images is calculated. Accordingly, information on the rates of change may be displayed in proximity to the classified images displayed in a time-series order. The user may manually select the images to be hidden on the basis of the displayed information on the rates of change. Images to be annotated may be selected based on the information on the rate of change.

As described above, similar to the system according to the second embodiment, the system according to this embodiment concerned can support selection of the images performed by the user until transition to the annotation screen, using the time-series display of the classified images.

### Fourth Embodiment

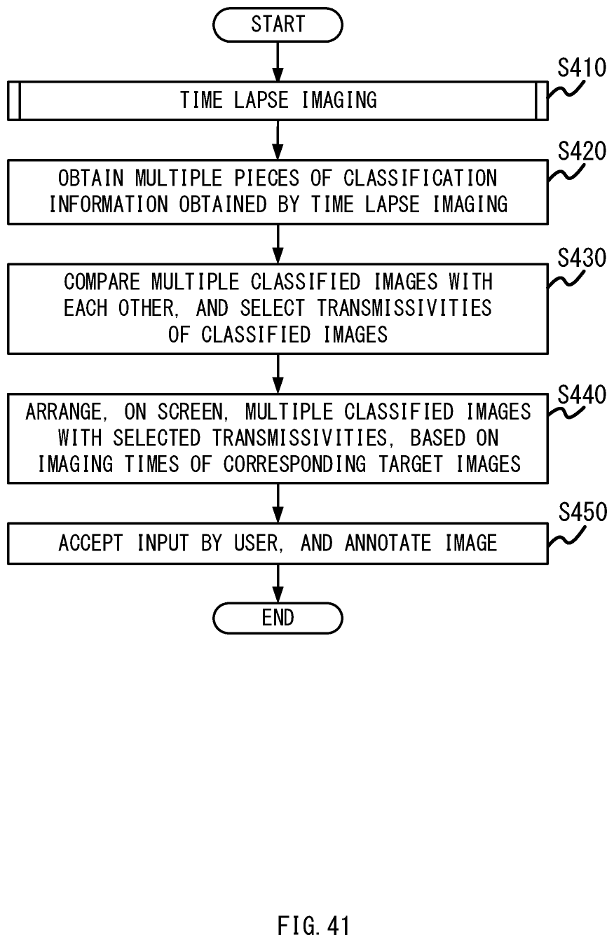

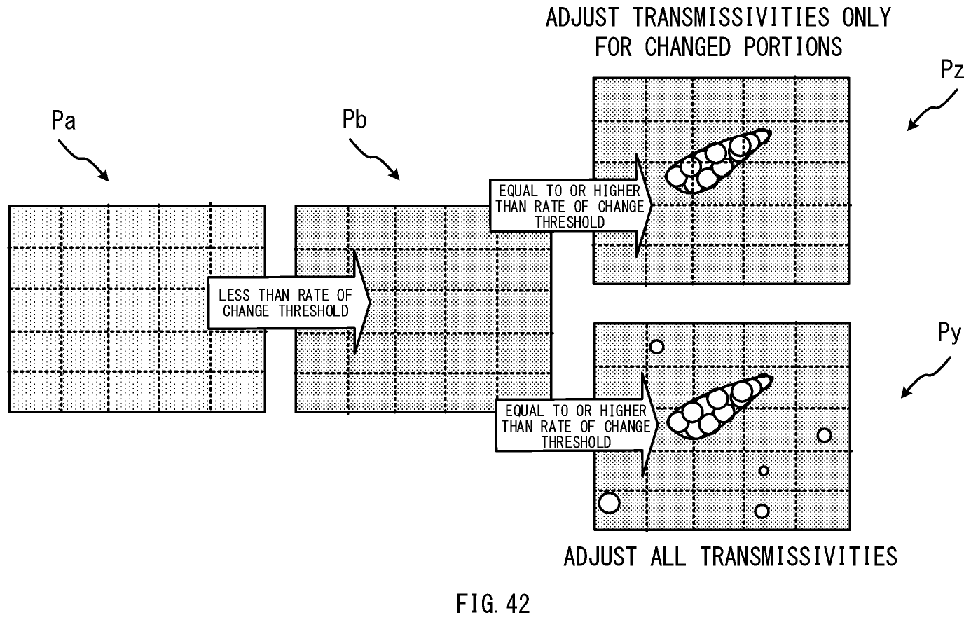

FIG. 41 is a flowchart showing an example of processes executed by the system according to this embodiment. FIG. 42 is a diagram for illustrating a method of determining the transmissivity of the classified images. Hereinafter, referring to FIGS. 41 to 42, processes performed by a system according to this embodiment are described. Note that the system according to this embodiment supports selection of images to be annotated, by performing the processes shown in FIG. 41. The system according to this embodiment (hereinafter simply described as the system) is different, in performing the processes shown in FIG. 41 instead of the processes shown in FIG. 29, from the system according to the second embodiment. However, the system is similar to the system according to the second embodiment in other points. Note that the processes shown in FIG. 41 are started by the processors 131 executing the program 132a. After the processes shown in FIG. 41 are started, first, the system performs time lapse imaging (step S410), and obtains multiple pieces of classification information obtained by the time lapse imaging (step S420). Note that the processes in steps S410 and S420 are similar to the processes in steps S200 and S210 of FIG. 29.

Subsequently, the control apparatus 130 selects transmissivities for classified images to be arranged on the screen on the basis of comparison between the pieces of classification information obtained in step S420 (step S430). Here, the control apparatus 130 is only required to select high transmissivities for largely changed images. There is no limitation to a specific selection method. For example, as shown in FIG. 42, the control apparatus 130 may calculate the rate of change between every adjacent images among the classified images (images Pa, Pb, Pz (or Py), . . . ) arranged in a time-series manner, and select high transmissivities for classified images having a rate of change equal to or higher than a threshold (the images Pz and Py in this example). Note that comparison may be made in units of images, and the transmissivities may be adjusted in units of images (see the image Pz, for example). Alternatively, comparison may be made in units of pasted images, and the transmissivities may be adjusted in units of pasted images (see the image Py, for example). Alternatively, comparison may be made in units of predetermined areas in the image (e.g., 10×10 pixels), and the transmissivities may be adjusted in units of predetermined regions.

When the transmissivities are selected, the control apparatus 130 arranges, on the screen, the selected classified images with the selected transmissivities, on the basis of the imaging times of the target images corresponding to the respective classified images (step S440). Here, the control apparatus 130 arranges the classified images with the selected transmissivities, in a manner of being superimposed on the corresponding target images. Accordingly, the largely changed target images is viewed translucently through the classified image, which can be used as reference for selection of the images to be annotated.

After multiple classified images are arranged on the screen, the system accepts an input by the user, and annotates the image (step S450). Note that the process of step S450 is similar to the process in step S4 of FIG. 5.

As described above, similar to the system according to the second embodiment, the system according to this embodiment concerned can support selection of the images performed by the user until transition to the annotation screen, using the time-series display of the classified images.

### Fifth Embodiment

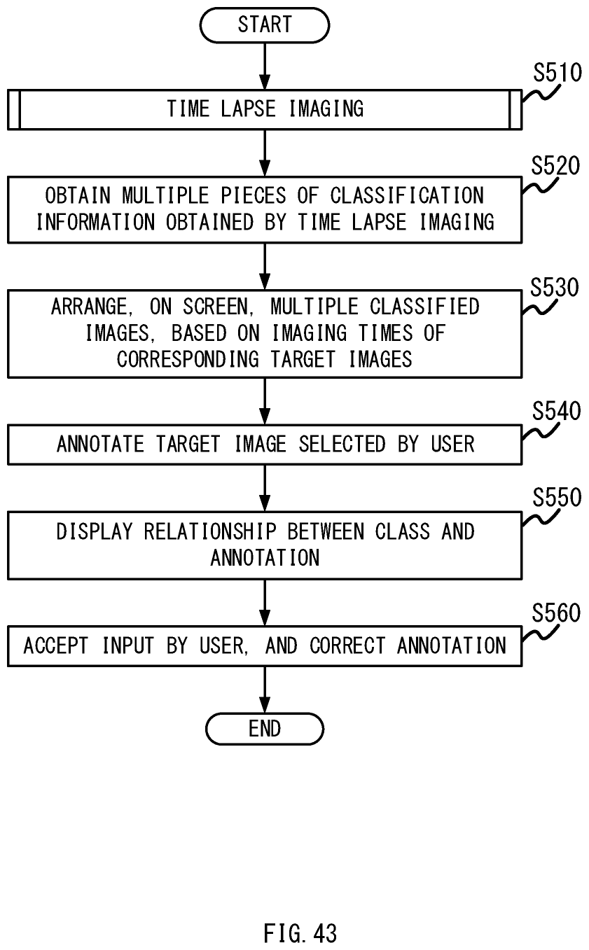

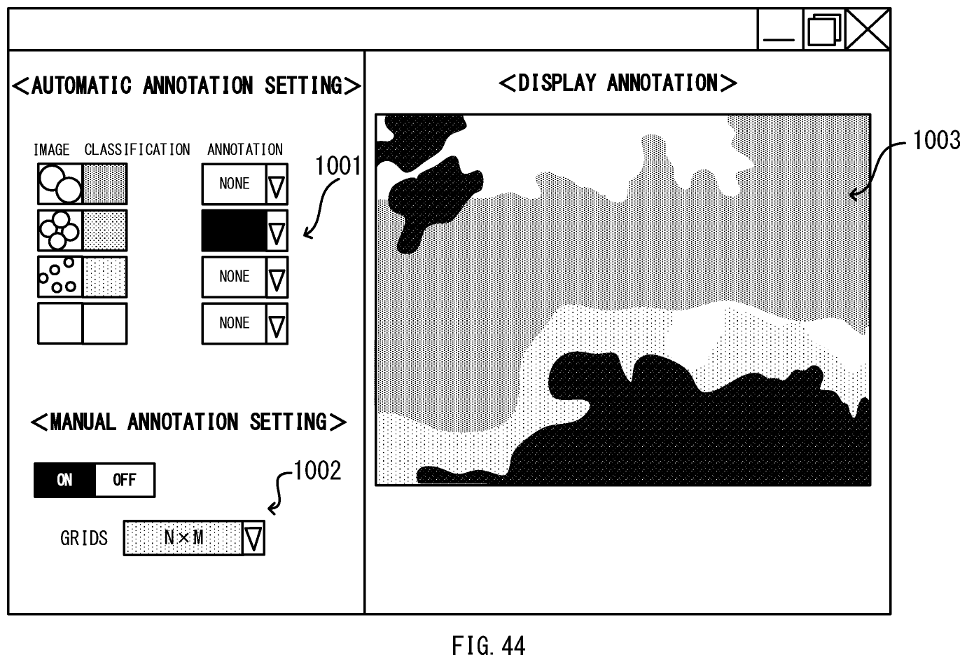

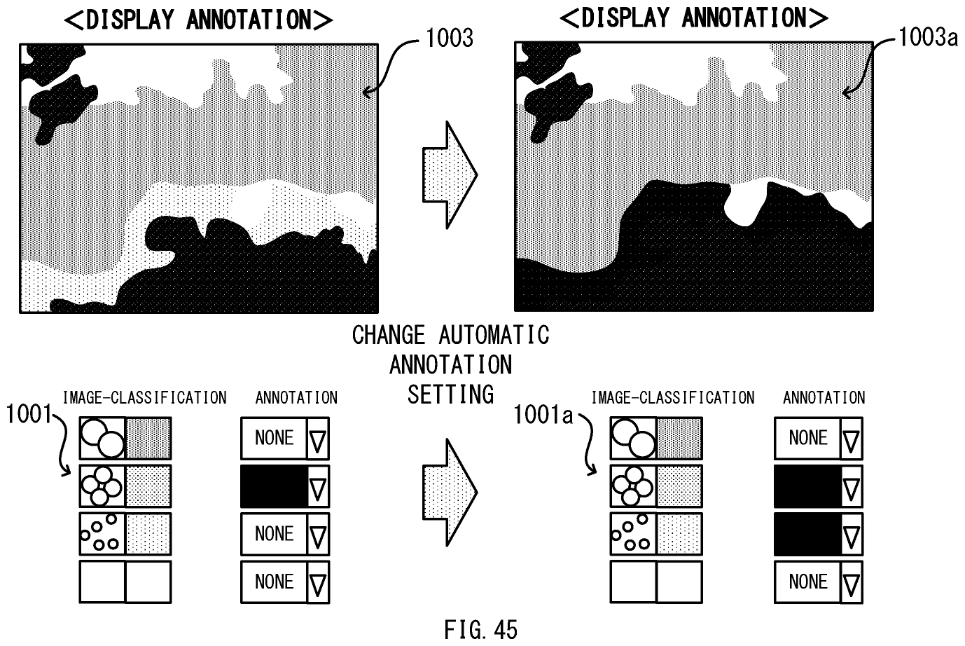

FIG. 43 is a flowchart showing an example of processes executed by the system according to this embodiment. FIG. 44 shows still another example of an annotation screen. FIGS. 45 to 47 are diagrams for illustrating the annotation adjustment method. Hereinafter, referring to FIGS. 43 to 47, processes performed by a system according to this embodiment are described. Note that the system according to this embodiment supports selection of images to be annotated, by performing the processes shown in FIG. 43. The system according to this embodiment (hereinafter simply described as the system) is different, in performing the processes shown in FIG. 43 instead of the processes shown in FIG. 29, from the system according to the second embodiment. However, the system is similar to the system according to the second embodiment in other points. Note that the processes shown in FIG. 43 are started by the processors 131 executing the program 132a.

After the processes shown in FIG. 43 are started, first, the system performs time lapse imaging (step S510), and obtains multiple pieces of classification information obtained by the time lapse imaging (step S520). A shown in FIG. 31, the system further arranges the generated classified images on the screen, on the basis of the imaging times of the target images corresponding to the respective classified images (step S530). Note that the processes in steps S510 and S530 are similar to the processes in steps S200 to S220 of FIG. 29.

Subsequently, when the user selects the target image to be annotated based on the classified images arranged on the screen, the control apparatus 130 annotates the target image selected by the user (step S540). Here, the control apparatus 130 may automatically annotate the target image selected by the user, on the basis of the classified image corresponding to the target image selected by the user. Specifically, the control apparatus 130 may annotate regions that belong to predetermined classes. For example, the control apparatus 130 may identify the regions belonging to the predetermined classes, on the basis of the classified images corresponding to the target images selected by the user, and annotate the identified regions among the target images selected by the user. Note that the control apparatus 130 may annotate the regions that are regions belonging to the predetermined class and have been subjected to highly reliable classification. After the automatic annotation, the control apparatus 130 causes the display device 134 to display the relationship between the automatically assigned annotations and the classes (step S550). Here, for example, the control apparatus 130 may cause the display device 134 to display an annotation screen shown in FIG. 44. The annotation screen shown in FIG. 44 includes a setting 1001 that is automatic annotation setting, a setting 1002 that is a manual annotation setting, and an annotated image 1003. The setting 1001 indicates the relationship between the class and the annotation. In this case, setting of automatically annotating the second class from the top is indicated.

Note that an image obtained by annotating the target image is used as the training data. The annotated image 1003 displayed on the annotation screen is not limited to an image obtained by annotating the target image. As shown in FIG. 44, the image obtained by annotating the classified image may be displayed. Further alternatively, an image obtained by annotating the image obtained by superimposing the classified image and the target image on each other may be displayed. The image obtained by annotating the target image may be displayed. That is, at least one of the classified image and the target image (assigned an annotation) may be displayed.

The user verifies the annotated image 1003 and the like on the annotation screen, and determines whether the annotation has been appropriately performed. After the necessity of correcting the annotation is recognized, the user performs operations, such as of changing of the automatic annotation setting, and activation of the manual annotation setting, and instructs the control apparatus 130 to correct annotation. The control apparatus 130 accepts an input by the user, and corrects the annotation (step S560).

Hereinafter, an example is described where an input by the user for correcting the annotation is performed by a click operation using a mouse. Alternatively, the input by the user may be performed through a direct input with a finger or a stylus. The information (annotation information) input by the user through the input device 133 is accepted by an acceptance unit of the control apparatus 130. The acceptance unit may be, for example, processors in the control apparatus 130. When the accepted annotation information is output to the display device, the acceptance unit may appropriately transform the annotation information into a form suitable to output.

FIG. 45 shows situations where the annotation is corrected by the user changing the automatic annotation setting. Here, the setting 1001 of annotating only the second class is changed to a setting 1001a of annotating the second and third classes, which changes the annotated image from the image 1003 to an image 1003a. As described above, the user may correct the annotation by changing the automatic assigning setting. In this case, only by changing the setting, correction can be easily performed.

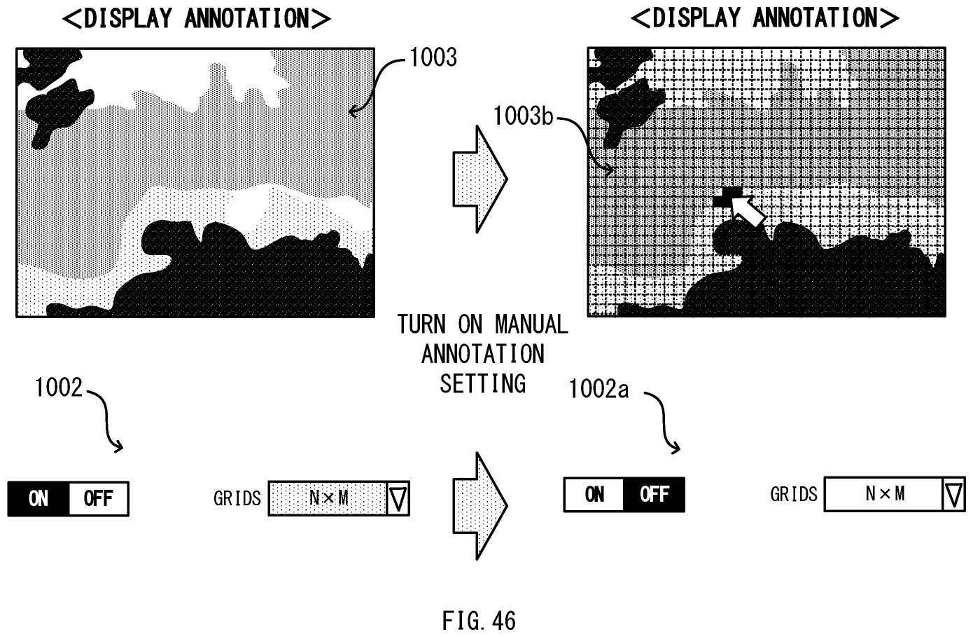

FIG. 46 shows situations where the user activates the manual annotation setting, and annotates any region of the image. When the user changes the annotation manual assigning from OFF to ON, (changes from the manual assigning setting 1002 to the setting 1002a), grid lines for supporting manual annotation on the annotated image. The grid lines are lines that divide the image into small regions (N×M small regions in this example) as many as the number (the number of grids) designated by the setting. The small regions are regions encircled by the grid lines. The manually assigned annotation can be assigned in units of small regions. That is, the control apparatus 130 can annotate the target image, in units of small regions encircled by the grid lines, according to an input by the user. Note that the units of the small regions may be identical to or different from units of the target regions used for generating the classification information. In an example in FIG. 46, by manually adding an annotation, the annotated image is changed from the image 1003 to the image 1003b. As described above, the user may activate the manual annotation setting and correct the annotation. In this case, the annotation can be corrected with more flexibility.

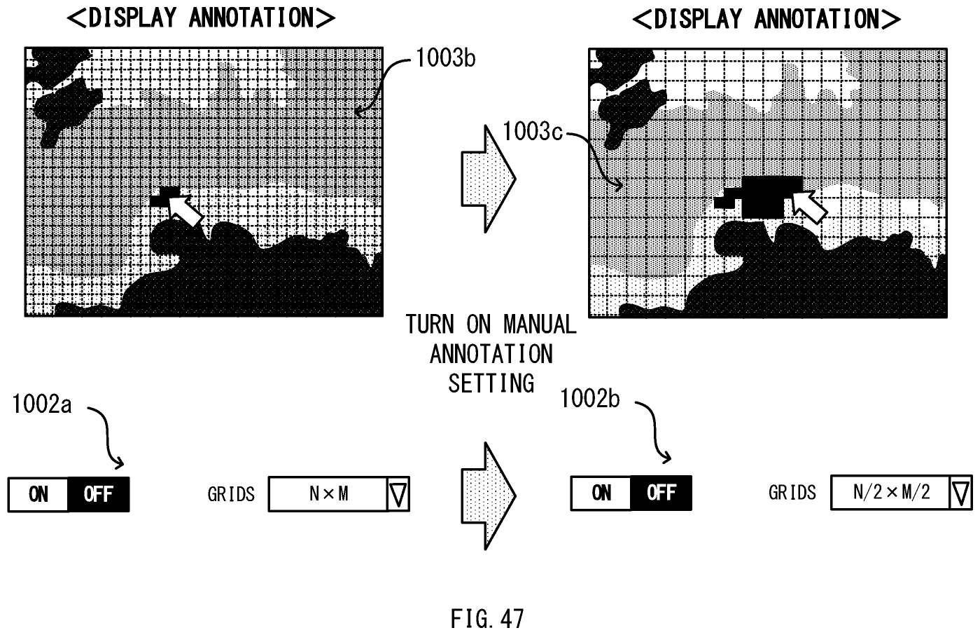

The user may change the number of grids as required. For example, as shown in FIG. 47, the setting 1002a may be changed to the setting 1002b. That is, the control apparatus 130 changes the size of the small region according to an input by the user. In an example in FIG. 47, by manually adding an annotation while changing the number of grids, the annotated image is changed from the image 1003b to the image 1003c. As described above, the user can efficiently assign an annotation by assigning the annotation with the setting of a relatively smaller number of grids. Conversely, by assigning the annotation with a relatively large number of grids, for example, a case where a fine region assigning, such as on the edge portions of cells, is required can also be supported. In conformity with the form of the regions to be annotated, the annotation can be correctly assigned. Consequently, by manually assigning the annotation while changing the number of grids as required, appropriate annotation can be effectively and appropriately performed. Furthermore, by displaying the grid lines, the user can correctly grasp which region is annotated by one selection.

As described above, the system according to this embodiment also can exert advantageous effects similar to those of the system according to the second embodiment. The system according to this embodiment automatically annotate the image selected by the user, thereby allowing the load of the annotation operation on the user to be significantly reduced. Furthermore, by the user verifying the automatically assigned annotations and correcting only required points, a high level equivalent to that in the case of manually maintaining the reliability of annotation can be maintained. Accordingly, appropriate annotations can be efficiently assigned. By allowing the user to freely set the units of annotations, the efficiency and correctness of the annotation operation can be achieved at a higher level in a compatible manner.

The embodiments described above is a specific example in order to facilitate understanding of the invention. The present invention is not limited to these embodiments. Modified embodiments obtained by modifying the embodiments described above, and alternative embodiments that substitute the embodiments described above can be encompassed. That is, each embodiment may allow the configuration elements to be modified in a range without departing from the spirit and scope. By appropriately combining multiple configuration elements disclosed in one or more embodiments, new embodiments can be implemented. Some configuration elements may be removed from the configuration elements indicated in each embodiment, or some configuration elements may be added to the configuration elements indicated in the embodiments. The order of the processing procedures shown in each embodiment may be replaced as long as there is no contradiction. That is, the annotation support system, method and computer-readable medium according to the present invention may be variously modified and changed in a range without departing from the description of the claims.

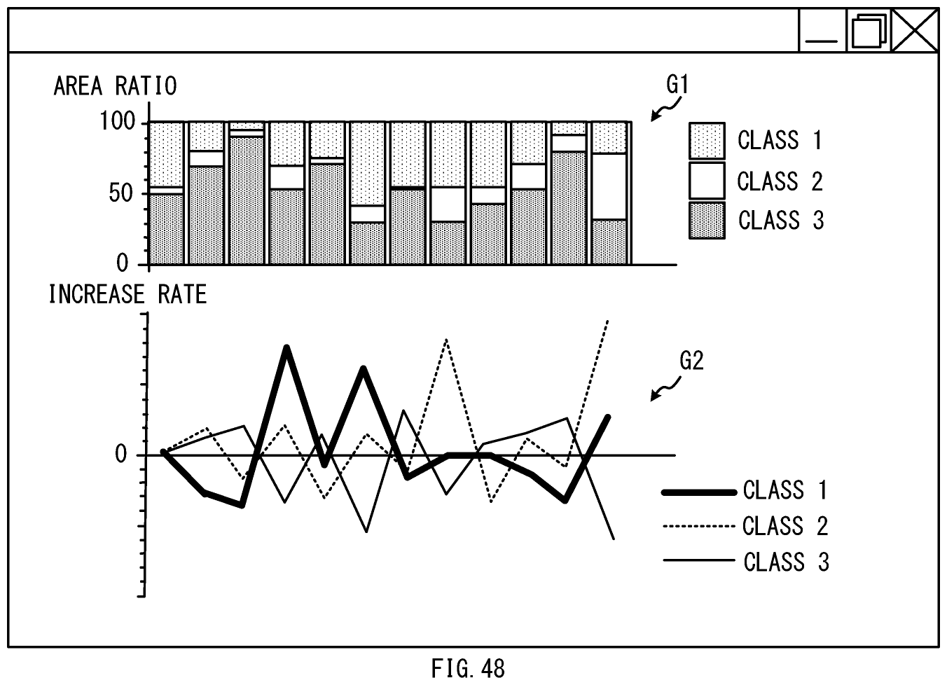

In the embodiments described above, the examples are described where by arranging the classified images in a time-series manner, the user can easily grasp the change occurring in the target image. However, the control apparatus 130 may sequentially display the classified images one by one in a time-series manner. As shown in FIG. 48, the control apparatus 130 may cause the display device 134 to display a graph G1 indicating the temporal change in class area ratio, and a graph G2 indicating the temporal change in increase rate, in addition to or instead of displaying the classified images in a time-series manner. Even with such a display, the user can be supported to grasp the change caused in the target image.

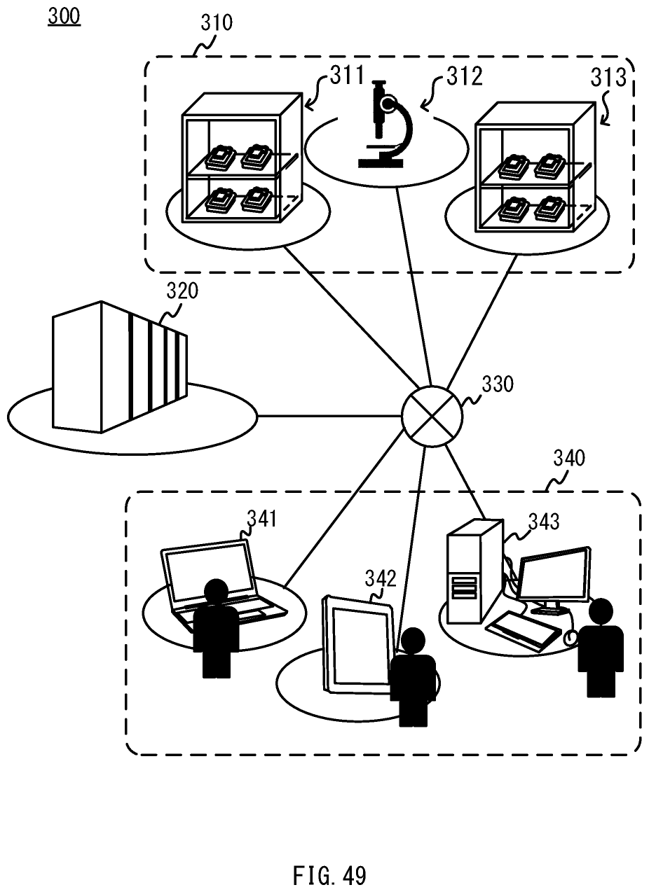

In the embodiments described above, the examples have been described where the imaging device 100 that obtains the target image images the cultured cells in the incubator. However, there is no limitation on the imaging apparatus. For example, the apparatus may be an endoscope, a biological microscope, or an industrial microscope. The target image is not limited to the image of the cultured cells. For example, the image may be an image used for pathological diagnostic, or an image where industrial products have been taken. The imaging device and the control apparatus may be connected to each other via the Internet. As shown in FIG. 49, the system 300 supporting annotation may include a plurality of imaging devices 310 (an imaging device 311, a microscope 312, and an imaging device 313), and may be connected to the control apparatus 320 via the internet 330. The control apparatus 320 may arrange the classified images on the screens of client terminals 340 (a client terminal 341, a client terminal 342, and a client terminal 343) allowing access via the Internet. Furthermore, the control apparatus 320 may function only as the classification unit that generates the classification information. The client terminal may function as a control unit that arranges the classified image on the screen. That is, the classification unit and the control unit may be provided in any apparatus in the system, and their roles may be played by different apparatuses. An annotation input by the user may be accepted from the client terminal 340. In this case, the client terminal 340 may transmit information on the accepted annotation to the control apparatus 320. The processors included in the client terminal 340 or the control apparatus 320 may transform the data into mutually compatible forms during exchange of data between the device and the apparatus. In this case, the user can assign an annotation irrespective of the place.

What is claimed is:

1. An image annotation support system, comprising:
a processor and a memory, the processor being configured to perform the following steps:
generating classification information that classifies a plurality of target regions constituting a target image, based on a feature represented in the target image, the target image being an image serving as a candidate to be annotated; and
arranging, on a screen of a display device, a classified image that visualizes the classification information, in a manner capable of being compared with the target image.

2. The system according to claim 1,
wherein the processor is configured to superimpose the classified image on the target image.

3. The system according to claim 2,
wherein the processor is configured to change a transmissivity of the classified image to be superimposed on the target image, according to a predetermined instruction.

4. The system according to claim 2,
wherein the processor is configured to determine a transmissivity of the classified image, based on reliability of the classified image.

5. The system according to claim 2,
wherein the classification information includes, with respect to each of the target regions:
class information that indicates classified classes; and
score information that indicates a stochastic score with respect to classification to the class, and
the processor is configured to determine transmissivities of a plurality of classified regions constituting the classified image, based on the score information on the corresponding target regions among the target regions.

6. The system according to claim 1,
the processor is configured to arrange, on the screen of the display device, a plurality of the classified images in which a plurality of pieces of generated classification information are visualized and which correspond to a plurality of the target images respectively taken at times different from each other, based on the times of the plurality of target images being taken.

7. The system according to claim 6,
wherein the processor is configured to select the plurality of classified images to be arranged on the screen of the display device, based on comparison between the plurality of pieces of generated classification information.

8. The system according to claim 6,
wherein the processor is configured to:
superimpose the plurality of classified images on the respective target images; and
determine transmissivities of the plurality of classified images, based on comparison between the plurality of pieces of classification information corresponding to the respective classified images.

9. The system according to claim 1,
wherein the classification information includes class information indicating classified classes, and
the processor is configured to change a display mode to be assigned to the class information in the classified image, according to a predetermined instruction.

10. The system according to claim 1,
wherein the target image is an image taken by imaging cells cultured in a culture vessel, and
the processor is configured to:
arrange a vessel image simulating the culture vessel, on the screen of the display device; and
arrange the classified image corresponding to the target image, on the vessel image, based on an imaging position of the target image on the culture vessel.

11. The system according to claim 10,
wherein the culture vessel is a multi-well plate,
the vessel image includes a plurality of well images that respectively simulate a plurality of wells included in the multi-well plate, and
the processor is configured to arrange a plurality of the classified images corresponding to a plurality of the target images where cells in the corresponding wells are taken, at positions corresponding to the plurality of well images.

12. The system according to claim 1,
wherein the processor is configured to include an entire or a part of a neural network that constitutes an auto encoder.

13. The system according to claim 1,
wherein the processor is configured to annotate the target image, based on the classified image.

14. The system according to claim 1,
wherein the processor is configured to:
arrange grid lines on at least one of the target image or the classified image that is arranged on the screen of the display device; and
annotating the target image, in units of small regions encircled by the grid lines, according to an input by a user.

15. The system according to claim 14,
the processor is configured to change sizes of the small regions according to the input by the user.

16. An image annotation support system, comprising:
a processor and a memory, the processor being configured to perform the following steps:
generating classification information that classifies a plurality of target regions constituting a target image, based on a feature represented in the target image, the target image being an image serving as a candidate to be annotated; and
arranging, on the screen of a display device, a plurality of the classified images in which a plurality of pieces of generated classification information are visualized and which correspond to a plurality of the target images respectively taken at times different from each other, based on the times of the plurality of target images being taken.

17. An image annotation support method, comprising:
generating classification information that classifies a plurality of target regions constituting a target image, based on a feature represented in the target image, the target image being an image serving as a candidate to be annotated; and
arranging, on a screen of a display device, a classified image that visualizes the classification information, in a manner capable of being compared with the target image.

18. An image annotation support method, comprising:
generating classification information that classifies a plurality of target regions constituting a target image, based on a feature represented in the target image, the target image being an image serving as a candidate to be annotated; and
arranging, on the screen of a display device, a plurality of the classified images in which a plurality of pieces of generated classification information are visualized and which correspond to a plurality of the target images respectively taken at times different from each other, based on the times of the plurality of target images being taken.

19. A non-transitory computer-readable medium storing an image annotation support program, the program causing a computer to execute processes of:
generating classification information that classifies a plurality of target regions constituting a target image, based on a feature represented in the target image, the target image being an image serving as a candidate to be annotated; and
arranging, on a screen of a display device, a classified image that visualizes the classification information, in a manner capable of being compared with the target image.

20. A non-transitory computer-readable medium storing an image annotation support program, the program causing a computer to execute processes of:
generating classification information that classifies a plurality of target regions constituting a target image, based on a feature represented in the target image, the target image being an image serving as a candidate to be annotated; and
arranging, on the screen of a display device, a plurality of the classified images in which a plurality of pieces of generated classification information are visualized and which correspond to a plurality of the target images respectively taken at times different from each other, based on the times of the plurality of target images being taken.
